(19) United States
(12) Patent Application Publication
(10) Pub. No.: US 2003/0033161 A1
(43) Pub. Date: Feb. 13, 2003

(54) Method and apparatus for generating and marketing supplemental information

(76) Inventors: Jay S. Walker, Ridgefield, CT (US); Jose A. Suarez, Fairfield, CT (US); Norman A. Goldstein, Scarsdale, NY (US); James A. Jorasch, Stamford, CT (US); Peter F. Burgess, Stamford, CT (US); Magdalena M. Fincham, Norwalk, CT (US); Geoffrey M. Gelman, Stamford, CT (US); Steven M. Santisi, Ridgefield, CT (US)

Correspondence Address: WALKER DIGITAL, FIVE HIGH RIDGE PARK, STAMFORD, CT, 06905, US

(21) Appl. No.: 10/132,761

(22) Filed: Apr. 24, 2002

Related U.S. Application Data
(60) Provisional application No. 60/286,173, filed on Apr. 24, 2001.

(51) Int. Cl. G06F 17/60

(52) U.S. Cl. 705/1

(57) ABSTRACT

The invention includes a process for providing incentives to sources to participate in interviews. Transcripts of interviews conducted according to a protocol are created that are saleable via, for example, the Internet. The protocol includes inserting tags into the recording to identify characteristics of the content of the recording. Further, the invention provides a method for redacting the recording using the inserted tags to generate a saleable version of the recording. The tags are used to exclude certain inappropriate content and to generate meta-data regarding the recording for marketing the recording. In some embodiments, interview participants may be compensated based upon sales of the recordings. Some embodiments of the invention include a recording device, a controller, and a user device. The recording device may be used to record an interview session between an interviewer and an interviewee. The recording device may communicate with the controller to convey the raw transcript of the interview session. The controller may include redacting software for modifying the interview transcript, and a voice recognition module for assisting in the redaction process. The voice recognition module may also assist in the creation of meta-tags describing the modified recording of the interview. The controller may further comprise a server for hosting Web pages. A user device in communication with the controller via the Internet may allow a user to peruse Web pages displaying the meta-tags and links that allow purchase of copies of associated interesting portions of the redacted interview transcripts as hosted by the controller.

### RELATED APPLICATIONS

This application claims priority to commonly-owned, co-pending U.S. Provisional Patent Application No. 60/286,173, filed Apr. 24, 2001, entitled “Source Interviews”; which is incorporated herein by reference in its entirety for all purposes.

This application is related to commonly owned, co-pending U.S. Patent Application No. 10/___,___ , filed Apr. 15, 2002, entitled “Method And Apparatus For Marketing Supplemental Information;” commonly owned, co-pending U.S. patent application Ser. No. 09/604,898 filed Jun. 28, 2000, entitled “Method and Apparatus for Conducting or Facilitating A Promotion;” and commonly owned, co-pending U.S. patent application Ser. No. 09/422,719, filed Oct. 22, 1999, entitled “Method And Apparatus For Distributing Supplemental Information Related To Printed Articles,” all of which are incorporated herein by reference in their entirety for all purposes.

### FIELD OF THE INVENTION

The present invention relates to methods and apparatus for obtaining and selling information. More specifically, the present invention relates to obtaining, filtering, storing, arranging, displaying, selling, and/or providing access to information that may be pertinent to a primary (or summary) document but may only be referenced or partially included in the primary document.

### BACKGROUND OF THE INVENTION

Tabloid publications such as the National Enquirer®, The Star®, and The Globe®, enjoy wide circulation. The Enquirer® alone has a circulation of more than 2 million. In addition, sports are a national pastime in the United States. Professional baseball, football, basketball, hockey, and other sports all have widespread and devoted followings. For example, the Superbowl, one of the largest annual sports events in the world, frequently draws more than 100 million viewers. Outside the United States, sports such as soccer also attract huge followings. Together, readers of tabloids and sports fans represent a very substantial number of paying information consumers.

Over the course of a year, a typical magazine may conduct three to five thousand interviews. The magazine may go to great effort and expense to seek and question sources for its interviews. However, after extracting bits of information to make a story, the rest of the interviews are frequently discarded. Methods are needed to capitalize on the interviews more completely, not just bits of content extracted from the interviews.

People who are interviewed for a tabloid story may typically receive a lump sum payment. Sources have little if any vested interest in how well their stories sell. Therefore, they may not be motivated to seek out and to tell the most interesting stories. Sports figures typically receive nothing for an interview. They too are not as motivated as they might be to provide interesting comments and insights. Methods are needed to motivate interview participants to provide information that is interesting to information consumers.

Readers of tabloid articles often desire to learn more about the topic of the article. However, there is often little recourse but to wait for follow-up articles or to seek out similar articles in competing tabloids. Likewise, sports fans often desire to hear more analysis of a game by a participant than is typically presented in conventional media. The fans may want to hear, for example, why the pitcher of a baseball team was removed from the game at such a critical juncture. Methods are needed for satisfying reader demand for supplemental information and sports fan demand for commentary by sports figures.

A raw transcript of an interview typically cannot be made available to the public. This may be because there can be inappropriate content in the interview transcript. Modifying a raw transcript to remove inappropriate content may be a tedious and time consuming manual process. Thus, systems and methods are needed to generate a modified transcript of an interview without creating significant new time commitments or responsibilities for a journalist or an editor. What is further needed are systems and methods for profitably disseminating the modified transcripts.

### BRIEF DESCRIPTION OF THE DRAWINGS

FIG. 1A is a block diagram illustrating an example system according to some embodiments of the present invention.

FIG. 1B is a block diagram illustrating an example system according to some alternative embodiments of the present invention.

FIG. 2 is a block diagram illustrating an example of a controller 102 as depicted in FIGS. 1A and 1B according to some embodiments of the present invention.

FIG. 3 is a block diagram illustrating an example of a recording device 106 as depicted in FIGS. 1A and 1B according to some embodiments of the present invention.

FIG. 4 is a block diagram illustrating an example of a user device 104 as depicted in FIGS. 1A and 1B according to some embodiments of the present invention.

FIG. 5 is an example illustration of a Web page depicting an example display of supplemental information being made available for sale according to some embodiments of the present invention.

FIG. 6 is a second example illustration of a Web page depicting an example display of supplemental information being made available for sale according to some embodiments of the present invention.

FIG. 7 is an example illustration of an advertisement for supplemental information available for sale according to some embodiments of the present invention.

FIG. 8 is a table illustrating an example data structure of an example rules of engagement database 208 as depicted in FIG. 2 for use in some embodiments of the present invention.

FIGS. 9A and 9B are a table illustrating an example data structure of an example of an interview database 210 as depicted in FIG. 2 for use in some embodiments of the present invention.

FIG. 10 is a table illustrating an example data structure of an example interview questions database 212 as depicted in FIG. 2 for use in some embodiments of the present invention.

FIG. 11 is a table illustrating an example data structure of an example user database 214 as depicted in FIG. 2 for use in some embodiments of the present invention.

FIG. 12 is a table illustrating an example data structure of an example source database 216 as depicted in FIG. 2 for use in some embodiments of the present invention.

FIG. 13 is a flow diagram illustrating an exemplary process for preparing supplemental information for sale according to and for use in some embodiments of the present invention.

FIGS. 14A to 14D are a flow diagram illustrating details of an exemplary process for performing a redaction Step S3 as depicted in FIG. 13 according to and for use in some embodiments of the present invention.

FIG. 15 is a flow diagram illustrating a second exemplary process for preparing supplemental information for sale according to and for use in some embodiments of the present invention.

### DETAILED DESCRIPTION OF THE INVENTION

Various embodiments of the disclosed invention solve the above and other drawbacks of the prior art by providing a system for obtaining, storing, displaying, and selling information that is pertinent to a document or other presentation of information, but may not be fully contained in the document. In addition, the present invention provides an incentive system for motivating the creation of saleable supplementary content.

According to some embodiments of the present invention, an interviewer, for example, offers a potential interview participant compensation for participating in an interview. The interview may be conducted according to a protocol and recorded. After the interview, the recording maybe analyzed and then, using tags inserted according to the protocol and identified in the analysis, is redacted by the system of the present invention. The redacted interview is offered to a potential information consumer in a saleable format. Participants in the interview may be compensated based on sales of the interview recording. In some embodiments the system may extract from the transcript the questions that were asked, transcribe them into text, and display them on a Web page. A consumer who is considering paying to listen to the interview may then review the questions that were asked before committing to purchase the interview recording. The system may also divide the transcript into smaller portions, each portion corresponding to a single question and answer. That way, a consumer may pay to receive only the answers that interest him. Along with other information about the interview, the system may determine and display the length of the entire interview or smaller portions of it. The length of the interview may then be another factor made available for a purchaser to consider before paying to receive a recording of the interview.

The system analyzes the interview based on tags interspersed in the transcript of the interview as a result of the interviewer following the protocol mentioned above. Tags include words or phrases such as “question” or “off the record.” When the system encounters such tags in its analysis, the subsequent portion of the transcript is processed according to predefined rules. For example, when encountering an “off the record” tag, the system may eliminate the ensuing portion of the transcript, until encountering an “on the record” tag.

In some embodiments, once the interview has been conducted and the raw transcript has been redacted, the interview may be referenced in a news or magazine article. For example, a quote from the interviewee may be followed by a superscript numeral. At the end of the article, a footnote may list the same numeral with a link to a Web site containing the full audio and/or video transcript of the interview from which the quote was derived. In some embodiments, access to the link may be restricted to paying customers. In some embodiments, participants may be compensated based upon the number of paying customers accessing the link.

According to some embodiments, a source bears witness to an event of interest to a magazine's or newspaper's readership. The source then contacts the magazine and offers to provide his story. A journalist with the magazine then negotiates an agreement with the source whereby the source receives compensation in exchange for being interviewed. The source may receive a percentage of the revenue from the sale of the interview to the public. Therefore, a source is motivated to give an interesting interview that might generate substantial sales. The journalist too may be given a percentage of the sales of an interview. The journalist is then also motivated to seek out interesting sources and to conduct entertaining interviews. In some embodiments, the source may be the journalist with a prearranged compensation agreement.

The interview between the source and the journalist is recorded. Before being put up for sale, the audio transcript of the interview is “prepped,” or modified so as to make it suitable for the public. The prepping process may involve eliminating portions of the interview that were understood to be off the record; eliminating redundancies; eliminating verbal crutches; eliminating vulgar language; eliminating long pauses; speeding up the interview; and making other modifications. The source's voice may also be disguised, depending on the degree to which the source wishes to remain anonymous.

After being prepped, in some embodiments the interview is converted into a sound file, such as an MP3, and posted on the Internet. The interview may also be advertised for sale in a magazine, such as a supermarket tabloid, carrying a story related to the interview. The interview may even be the original source of the story. The advertisement may give descriptive information about the interview, such as its length, subject, and price. The advertisement may also refer a consumer to the Web site from which the consumer may download the interview. When the consumer visits the Web site, the consumer may enter a credit card number and agree to purchase an interview. The consumer may purchase multiple interviews at a reduced per-interview price. Then, the interview is sent to the consumer's personal computer, or personal digital assistant, and the consumer may play the interview.

In some embodiments, rather than being promoted in magazines, sports interviews might be promoted in sports articles in a daily newspaper. A footnote to an article would refer a reader to a Web site where the reader may download an interview with a sports figure mentioned in the article. In some embodiments, a sports figure's team, or other related entity, might share in the sales of an interview given by the sports figure.

With these and other advantages and features of the invention that will become hereinafter apparent, the nature of the invention may be more clearly understood by reference to the following detailed description of the invention, the appended claims and to the several drawings included herein.

In the following description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized and that structural, logical, software, and electrical changes may be made without departing from the scope of the present invention. The following description is, therefore, not to be taken in a limited sense, and the scope of the present invention is defined by the appended claims.

Applicants have recognized that a need exists for systems and methods to allow consumers of information to access further data of interest to them. The present invention allows a potential purchaser of an interview transcript to view information about the interview before deciding whether to make the purchase. Such information may include, for example, the questions asked and the length of the answers to the questions. Further, without requiring substantial expense or significant alteration of existing journalism methods, the present invention facilitates increased revenue for news organizations or other entities from sales of supplementary news or other information. In addition, the present invention provides an efficient, automated, low cost method of redacting inappropriate content from raw transcripts making the transcripts publicly saleable and thus, more valuable. In some embodiments of the present invention, an interview participant profits from the sale of his story. Sources are therefore encouraged to come forward with interesting stories, and the public benefits from freer flow of information.

A. Definitions

Throughout the description that follows and unless otherwise defined, the following terms will refer to the meanings provided in this section. These terms are provided to clarify the language selected to describe the embodiments of the invention both in the specification and in the appended claims.

The terms “products,” “goods,” “merchandise,” and “services” shall be synonymous and refer to anything licensed, leased, sold, available for sale, available for lease, available for licensing, and/or offered or presented for sale, lease, or licensing including packages of products, subscriptions to products, contracts, information, services, and intangibles.

The term “merchant” shall refer to an entity who may offer to sell, lease, and/or license one or more products to a consumer (for the consumer or on behalf of another) or to other merchants. For example, merchants may include sales channels, individuals, companies, manufacturers, distributors, direct sellers, re-sellers, and/or retailers. Merchants may transact out of buildings including stores, outlets, malls and warehouses, and/or they may transact via any number of additional methods including mail order catalogs, vending machines, online Web sites, and/or via telephone marketing. Note that a producer or manufacturer may choose not to sell to customers directly and in such a case, a retailer may serve as the manufacture's or producer's sales channel.

The term “user device” shall refer to any device owned or used by a consumer capable of accessing and/or displaying online and/or offline content. Such devices may include gaming devices, personal computers, personal digital assistants, point of sale terminals, point of display terminals, kiosks, telephones, cellular phones, automated teller machines (ATM), etc.

The term “gaming device” shall refer to any gaming machine, including slot machines, video poker machines, video bingo machines, video keno machines, video blackjack machines, video lottery terminals, arcade games, game consoles, personal computers logged into online gaming sites, etc. Gaming devices may or may not be owned by a casino and/or may or may not exist within a casino.

The term “controller” shall refer to a device that may be in communication with third-party servers, and/or a plurality of user devices, and may be capable of relaying communications to and from each.

The term “input device” shall refer to a device that is used to receive an input. An input device may communicate with or be part of another device (e.g. a user device, a third-party server, a controller, etc.). Some examples of input devices include: a bar-code scanner, a magnetic stripe reader, a computer keyboard, a point-of-sale terminal keypad, a touch-screen, a microphone, an infrared sensor, a sonic ranger, a computer port, a video camera, a digital camera, a GPS receiver, a motion sensor, a radio frequency identification (RFID) receiver, a RF receiver, a thermometer, a pressure sensor, and a weight scale.

The term “output device” shall refer to a device that is used to output information. An output device may communicate with or be part of another device (e.g. a user device, a third-party server, a controller, etc.). Some examples of output devices include: a cathode ray tube (CRT) monitor, liquid crystal display (LCD) screen, light emitting diode (LED) screen, a printer, an audio speaker, an infra-red transmitter, a radio transmitter, etc.

The term “I/O device” shall refer to any combination of input and/or output devices.

The term “redaction” shall refer to a process by which an interview transcript or other information source is modified. A redaction process may eliminate portions of an interview that, for example, are off the record, contain inappropriate language, and/or are intended for a restricted audience. A redaction process may add additional content or additional information regarding the information source.

The term “rules of engagement” shall refer to a protocol that may be followed by an interviewer and/or an interviewee. The protocol describes how the interviewer may use information obtained during the interview, and how the use may be signaled. For example, as part of a set of rules of engagement, an interviewer may agree to not make certain information available to the public. The interviewee may signal what information should not be made publicly available by prefacing the information with an “off the record” tag. In some embodiments, a set of tags to be used for a recording completely defines a given rules of engagement protocol.

The term “tag” shall refer to information used for redaction. In some embodiments, a tag may include a voiced word or phrase, such as “off the record,” and in some embodiments, a tone, a beep, and/or other audio or visual signal maybe used. In the process of redaction, the system of the present invention may recognize the tag “off the record,” and consequently not include an associated portion of a raw transcript in a modified transcript of an interview.

Other tags may be used to convey other information to a redacting system. Such tags may include, for example, “end interview,” “on the record,” “question,” “end question,” “for attribution,” “not for attribution,” etc. The end interview tag may be, for example, voiced by a journalist during the course of a recorded interview so as to alert a redacting system that the interview is over. Likewise, an end question tag may be voiced by a journalist during the course of an interview so as to alert the redacting system that the journalist has just finished asking a question. A for attribution tag may be used, for example, to indicate that an associated portion of an interview may be permitted to be publicly attributed to the interviewee.

The term “meta-tag” shall refer to information about an interview or other information source. A meta-tag may include the length of the interview, the questions that were asked, the interviewee's name, the subject of the interview, and so on. Meta-tags may allow a potential purchaser of the interview to review information about the interview before deciding to commit time or money to listening to the interview. The term “meta-tag” is used distinctly from the term “tag” in that the former refers to information that may be displayed to a potential purchaser, while the latter refers to information that may be used in redacting the interview transcript or other information source.

The terms “transcript” and “interview transcript” shall be synonymous and refer to any form of representation of an act, a status, a speech, and/or a dialog by or between any number of entities. Thus, for example, a transcript may include an image of an interview between two people, a recording of an interview between two people, a transcribed version of an interview, a written description of a pantomime, a recording of music, sounds of crowd noise, an image of a car crash, speech notes, a written copy of a speech, a video of a speech, written dialogue, a reading on a scale, an indication on a sensor, etc.

The term “interview participant” shall refer to any entity whose act, status, speech, dialog, and/or image is represented by an interview transcript. An interview participant may be a source of information for an interview.

The term “source” shall refer to a person who provides information in the format of an interview. The information might be a recollection of an incident the source witnessed or took part in, insight into another person's character, or any rumor the source has heard. The source might also describe his interpretation of the events of a sports game.

The term “story” shall refer to the salient information or event(s) described by a source in an interview. A story is distinct from an interview.

The term “compensation agreement” shall refer to an agreement that details the amount and the nature of compensation to be given a source in exchange for participating in an interview. The agreement may stipulate that a source be compensated in proportion to the revenues earned from the sale of the source's interview. Compensation may occur in the form of cash, goods, or recognition. A compensation agreement may or may not be a legally binding agreement.

The term “locked” shall refer to the state of an interview sound file that cannot be played. The sound file might be encrypted, for example, requiring a decryption key in order to be unlocked and played.

The term “unlock key” shall refer to a code, password, or other mechanism that one may use to transform an interview transcript from a locked state to a state where one may listen to it.

The terms “processing” or “prepping” shall be synonymous and shall refer to modifying an interview transcript so as to make it saleable to the public. Processing may include redaction and/or manually removing inappropriate content, redundancies, verbal crutches, and long pauses. Processing may further include removing portions of an interview transcript that are off the record. Processing may be performed by different entities, separately or together, including a controller and/or a specialist.

The term “specialist” shall refer to a person who specializes in prepping interviews. A specialist may be a full time employee of a magazine or newspaper who is trained to listen for material in an interview transcript that would best be changed or eliminated before distribution of the interview to the public. A specialist may or may not be a journalist or an editor.

B. System

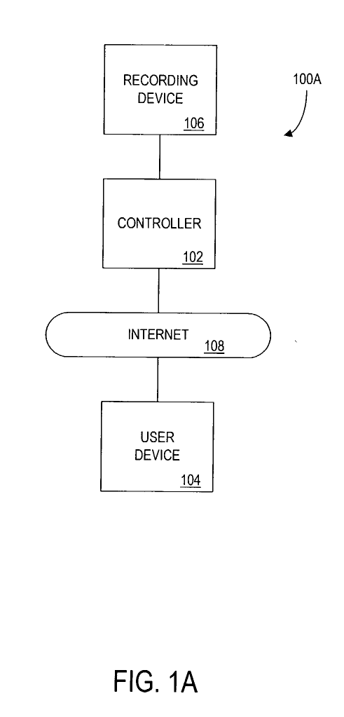

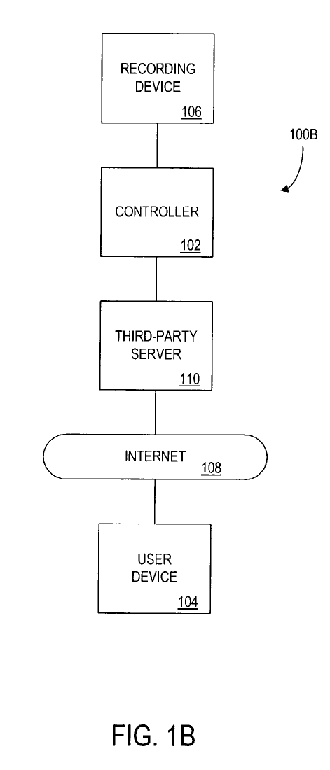

Referring now to FIG. 1A, a system 100A according to some embodiments of the present invention includes a controller 102 that is in one or two-way communication via the Internet 108 (or other communications link) with one or more user devices 104 and/or recording devices 106. In operation, the controller 102 may function under the control of a merchant or other entity that may also control the recording devices 106. For example, the controller 102 may be a server in a newspaper's reporting network, a server in a television station's network, or a server in an information merchant's (e.g. LEXIS®) online network. In some embodiments, the controller 102 and the recording device 106 may be one and the same.

Referring to FIG. 1B, an alternative system 100B according to some other embodiments of the present invention further includes one or more third party servers 110. A third-party server 110 may also be in one or two-way communication with the controller 102. However, as shown in the embodiment depicted in FIG. 1B, the third-party server 110 may be disposed between the controller 102 and the user devices 104. In some embodiments, controller 102 may include multiple servers, each under the control of different entities. In such an embodiment, the third-party server 100 may function as a consolidator of the information products of the entities operating the plurality of controller servers.

The primary difference between the two alternative embodiments depicted in FIGS. 1A and 1B is that the embodiment of FIG. 1B includes the third-party server 110 which may be operable by an entity both distinct and physically remote from the entity operating the controller 102. In operation, the third-party server 110 may perform the methods of the present invention by sending signals to the controller 102 relayed from the user devices 104. In such an embodiment, the third-party server 110 may function as a reseller of information owned or controlled by the controller 102. For example, an information merchant may operate a third party server 110 that communicates with a news organization's server (functioning as a controller 102) to provide consumers, via user devices 104, with fee-based access to redacted recordings of interviews. In the embodiment of FIG. 1A, the functions of the third-party server 110 may be consolidated into the controller 102.

An additional difference between the two embodiments depicted in FIGS. 1A and 1B relates to the physical topology of the system 100A, 100B. In both of the embodiments, each node may securely communicate with every other node in the system 100A, 100B via, for example, a virtual private network (VPN). Thus, all nodes may be logically connected. However, the embodiment depicted in FIG. 1B allows the third-party server 110 to serve as a single gateway between the nodes that will typically be operated by the owners of the information and the other nodes in the system 100B, i.e. nodes that may be operated by consumers of the information products.

In some embodiments, the recording devices 106 may each be controlled by different information merchants. The controller 102 may be operated by an entity that uses the present invention to, for example, serve as an information repository such as a commercial library. If there is a third-party server 110, it may be operated by an unrelated entity that merely permits the operators of the controller 102 to have access to consumers who are operating the user devices 104. Thus, in such an example embodiment, the system of the present invention may involve information merchants (operating recording devices 106), a customer acquisition service agent (operating the controller 102), third party network operators (operating third party servers 110), and consumers (operating user devices 104). In alternative embodiments, a merchant may operate a combined controller/recording device directly and the system may only involve an information merchant and a consumer.

In both embodiments pictured in FIGS. 1A and 1B, communication between each of the controller 102, the recording devices 106, the user devices 104, and/or the third party server 110, may be direct and/or via a network such as the Internet 106.

Referring to both FIGS. 1A and 1B, each of the controller 102, (the third-party server 110,) the recording devices 106, and the user devices 104 may comprise computers, such as those based on the Intel® Pentium® processor, that are adapted to communicate with each other. Any number of third party servers 110, recording devices 106, and/or user devices 104 may be in communication with the controller 102. In addition, the user devices 104 may be in one or two-way communication with the third-party server 110. The controller 102, the third-party server 110, the recording devices 106, and the user devices 104 may each be physically proximate to each other or geographically remote from each other. The controller 102, the third-party server 110, the recording devices 106, and the user devices 104 may each include input devices (not pictured) and output devices (not pictured).

As indicated above, communication between the controller 102, the third-party server 110, the recording devices 106, and the user devices 104, may be direct or indirect, such as over an Internet Protocol (IP) network such as the Internet 108, an intranet, or an extranet through a Web site maintained by the controller 102 (and/or the third-party server 110) on a remote server or over an online data network including commercial online service providers, bulletin board systems, routers, gateways, and the like. In yet other embodiments, the devices may communicate with the controller 102 over local area networks including Ethernet, Token Ring, and the like, radio frequency communications, infrared communications, microwave communications, cable television systems, satellite links, Wide Area Networks (WAN), Asynchronous Transfer Mode (ATM) networks, Public Switched Telephone Network (PSTN), other wireless networks, and the like.

Those skilled in the art will understand that devices in communication with each other need not be continually transmitting to each other. On the contrary, such devices need only transmit to each other as necessary, and may actually refrain from exchanging data most of the time. For example, a device in communication with another device via the Internet 108 may not transmit data to the other device for weeks at a time. The nodes of the system 100A, 100B may not remain physically coupled to each other. For example, the recording device 106 may only be connected to the system 100A, 100B when an interviewer has a raw interview transcript to upload to the controller 102.

The controller 102 (and/or the third-party server 110) may function as a “Web server” that presents and/or generates Web pages which are documents stored on Internet-connected computers accessible via the World Wide Web using protocols such as, e.g., the hyper-text transfer protocol (“HTTP”). Such documents typically include one or more hyper-text markup language (“HTML”) files, associated graphics, and script files. A Web server allows communication with the controller 102 in a manner known in the art. The recording devices 106 and the user devices 104 may use a Web browser, such as NAVIGATOR® published by NETSCAPE® for accessing HTML forms generated or maintained by or on behalf of the controller 102 and/or the third-party server 110.

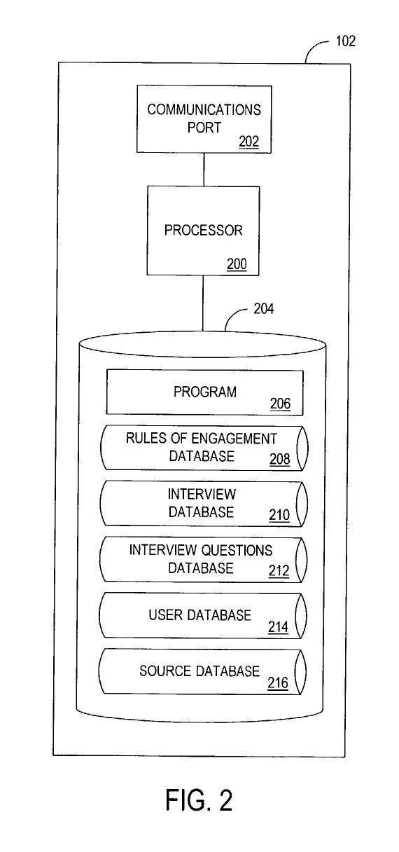

As indicated above, any or all of the controller 102, the third-party server 110, the recording devices 106 and the user devices 104 may include, e.g., processor based cash registers, telephones, interactive voice response (IVR) systems such as the ML400-IVR® designed by MISSING LINK INTERACTIVE VOICE RESPONSE SYSTEMS, cellular/wireless phones, vending machines, pagers, personal computers, portable types of computers, such as a laptop computer, a wearable computer, a palm-top computer, a hand-held computer, and/or a Personal Digital Assistant (PDA). Further details of the controller 102, the recording devices 106, and the user devices 104 are provided below with respect to FIGS. 2 through 4.

As indicated above, in some embodiments of the invention the controller 102 (and/or the third-party server 110) may include recording devices 106, and/or user devices 104. Further, the controller 102 may communicate with interviewers (information suppliers) directly instead of through the recording devices 106. Likewise, the controller 102 may communicate with consumers directly instead of through the user devices 104. Although not pictured, the controller 102, the third-party server 110, the recording devices 106, and the user devices 104 may also be in communication with one or more consumer and/or merchant credit institutions to effect transactions and may do so directly or via a secure financial network such as the Fedwire network maintained by the United States Federal Reserve System, the Automated Clearing House (hereinafter “ACH”) Network, the Clearing House Interbank Payments System (hereinafter “CHIPS”), or the like.

In operation, the recording device may be used to record an interview between an interviewer and an interviewee. Further, the recording devices 106 may transmit recordings to the controller 102 and the controller 102 may transmit redacted recordings to the user devices 104. In embodiments with a third-party server 110, the recording devices 106 may transmit recordings to the controller 102, the controller 102 may transmit the recordings to the third-party server 110, and the third-party server 110 may transmit redacted recordings to the user devices 104. Alternatively, the controller 102 may transmit redacted recordings to the third-party server 110. The user devices 104 may provide consumer information to the controller 102 (and/or the third-party server 110). The controller 102 (and/or the third-party server 110) may execute online transactions with consumers and/or interview participants via user devices 104 operated by consumers and/or interview participants. A user device 104 in communication with the controller 102 via the Internet 108 may be used to peruse Web pages hosted by the controller 102 displaying data regarding redacted interview transcripts that are available for purchase. In addition, a user device may be used by an interview participant to retrieve information regarding compensation received and/or to retrieve actual compensation for participation in an interview.

C. Devices

FIG. 2 is a block diagram illustrating details of an example of the controller 102 of FIGS. 1A and 1B (and/or the third-party server 110 of FIG. 1B). The controller 102 is operative to manage the system and execute the methods of the present invention. The controller 102 may be implemented as one or more system controllers, one or more dedicated hardware circuits, one or more appropriately programmed general purpose computers, or any other similar electronic, mechanical, electromechanical, and/or human operated device. For example, in FIG. 1B, the controller 102 is depicted as coupled to a third-party server 110. In the embodiment of FIG. 1B, these two servers may provide the same functions as the controller 102 alone in the embodiment of FIG. 1A.

The controller 102 (and/or the third-party server 110) may include a processor 200, such as one or more Intel® Pentium® processors. The processor 200 may include or be coupled to one or more clocks or timers (not pictured), which may be useful for determining information relating to, for example, a length of a recording, and one or more communications ports 202 through which the processor 200 communicates with other devices such as the recording devices 106, the user devices 104 and/or the third-party server 110. The processor 200 is also in communication with a data storage device 204. The data storage device 204 includes an appropriate combination of magnetic, optical and/or semiconductor memory, and may include, for example, additional processors, communication ports, Random Access Memory (“RAM”), Read-Only Memory (“ROM”), a compact disc and/or a hard disk. The processor 200 and the storage device 204 may each be, for example: (i) located entirely within a single computer or other computing device; or (ii) connected to each other by a remote communication medium, such as a serial port cable, a LAN, a telephone line, radio frequency transceiver, a fiber optic connection or the like. In some embodiments for example, the controller 102 may comprise one or more computers (or processors 200) that are connected to a remote server computer operative to maintain databases, where the data storage device 204 is comprised of the combination of the remote server computer and the associated databases.

The data storage device 204 stores a program 206 for controlling the processor 200. The processor 200 performs instructions of the program 206, and thereby operates in accordance with the present invention, and particularly in accordance with the methods described in detail herein. The present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein may be implemented in many different ways using a wide range of programming techniques as well as general purpose hardware systems or dedicated controllers. The program 206 may be stored in a compressed, uncompiled and/or encrypted format. The program 206 furthermore may include program elements that may be generally useful, such as an operating system, a database management system and “device drivers” for allowing the processor 200 to interface with computer peripheral devices. Appropriate general purpose program elements are known to those skilled in the art, and need not be described in detail herein.

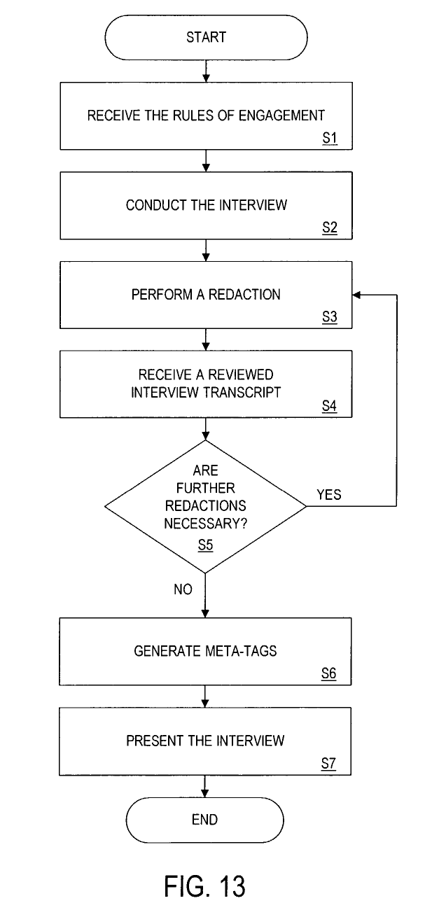

Further, the program 206 is operative to execute a number of invention-specific modules or subroutines including but not limited to one or more routines to upload, store, and organize recordings; one or more routines to redact recordings; one or more modules to recognize tags within recordings (e.g. voice recognition modules, image recognition modules, pattern recognition modules); one or more routines to generate meta-tags describing the redacted recordings; one or more routines to present redacted recordings for sale; one or more modules to implement a server for hosting Web pages; one or more routines to transact sales of information; one or more routines to download redacted recordings to user devices 104; one or more routines to receive information about a consumer; one or more routines to facilitate and control communications between recording devices 106, user devices 104, the controller 102, and/or a third party server 110; and one or more routines to control databases or software objects that track information regarding consumers, recordings, third parties, user devices 104, rules of engagement, meta-tags, tags, interviews, questions, and answers. Examples of some of these routines and their operation are described in detail below in conjunction with the flowcharts depicted in FIGS. 13, 14A to 14D, and 15.

According to some embodiments of the present invention, the instructions of the program 206 may be read into a main memory of the processor 200 from another computer-readable medium, such from a ROM to a RAM. Execution of sequences of the instructions in the program 206 causes processor 200 to perform the process steps described herein. In alternative embodiments, hard-wired circuitry or integrated circuits may be used in place of, or in combination with, software instructions for implementation of the processes of the present invention. Thus, embodiments of the present invention are not limited to any specific combination of hardware, firmware, and/or software.

In addition to the program 206, the storage device 204 is also operative to store (i) a rules of engagement database 208, (ii) an interview database 210, (iii) an interview questions database 212, (iv) a user database 214, and (v) a source database 216. The databases 208, 210, 212, 214, 216 are described in detail below and example structures are depicted with sample entries in the accompanying figures. As will be understood by those skilled in the art, the schematic illustrations and accompanying descriptions of the sample databases presented herein are exemplary arrangements for stored representations of information. Any number of other arrangements may be employed besides those suggested by the tables shown. For example, even though five separate databases are illustrated, the invention could be practiced effectively using one, two, three, four, six, or more functionally equivalent databases. Similarly, the illustrated entries of the databases represent exemplary information only; those skilled in the art will understand that the number and content of the entries may be different from those illustrated herein. Further, despite the depiction of the databases as tables, an object based model could be used to store and manipulate the data types of the present invention and likewise, object methods or behaviors may be used to implement the processes of the present invention. These processes are described below in detail with respect to FIGS. 13, 14A to 14D, and 15.

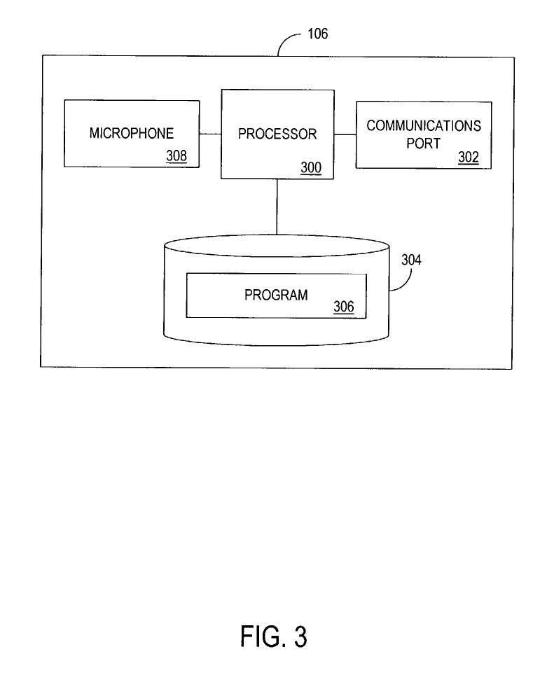

Turning to FIG. 3, a block diagram of an example recording device 106 is depicted. A recording device 106 according to the present invention may include a processor 300 coupled to a communications port 302, a data storage device 304 that stores a recording device program 306 and recordings, and a microphone 308. Although not pictured, a recording device 106 may include a video camera and/or any other type of input device capable of generating a signal that may be recorded. In addition, a recording device 106 may include a multi-tone sound generator that may be used to insert tones into a recording for use as tags. A recording device program 306 may include one or more routines to facilitate and control communications and interaction with the controller 102 as well as a user interface to facilitate making recordings. As indicated above, a recording device 106 may be implemented by any number of devices such as, for example, a tape recorder, a camcorder, a video cassette recorder, a digital video disc recorder, a telephone, an IVR system, a cellular/wireless phone, a security system, a television camera, a kiosk, a vending machine, a pager, a personal computer, a portable computer such as a laptop, a wearable computer, a palm-top computer, a hand-held computer, and/or a PDA.

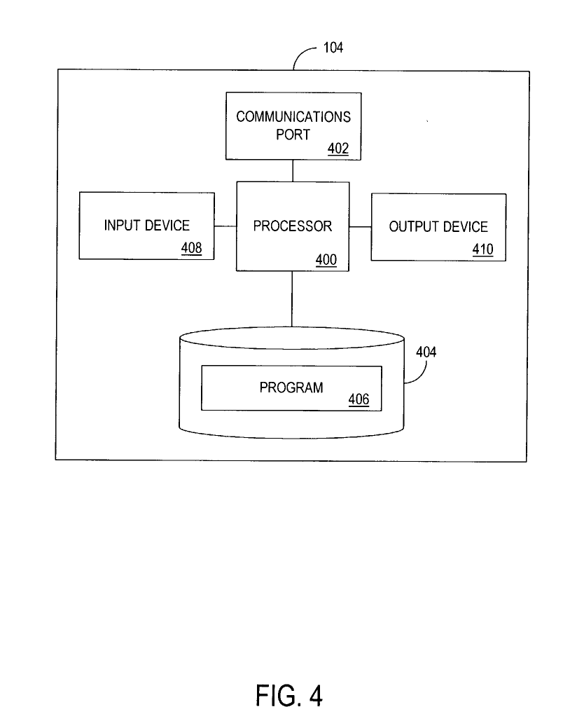

Turning to FIG. 4, a block diagram of an example user device 104 is depicted. A user device 104 according to the present invention may include a processor 400 coupled to a communications port 402, a data storage device 404 that stores a user device program 406, an input device 408, and an output device 410. A user device program 406 may include one or more routines to facilitate and control communications and interaction with the controller 102 as well as a user interface to facilitate communications and interaction with a consumer (e.g. an operating system, a Web browser, etc.).

In addition, a user device 104 may include additional devices to support other functions. For example, a user device 104 embodied in an ATM may additionally include a system for receiving, counting, and dispensing cash as well as a printing device for generating a receipt and/or a security camera. In another example, a user device 104 embodied in a gaming device may additionally include a system for generating and/or selling outcomes certified by a gaming authority. Such systems include slot machines which include conventional reel slot machines, video slot machines, video poker machines, video keno machines, video blackjack machines, and other gaming machines. In yet another example, a user device 104 embodied in a gasoline pump may additionally include a system for pumping, measuring, and managing the flow control of fuel. Further, many alternative input and output devices may be used in place of the various devices pictured in FIG. 4. Uses of these user device 104 components are discussed below in conjunction with the description of the methods of the present invention.

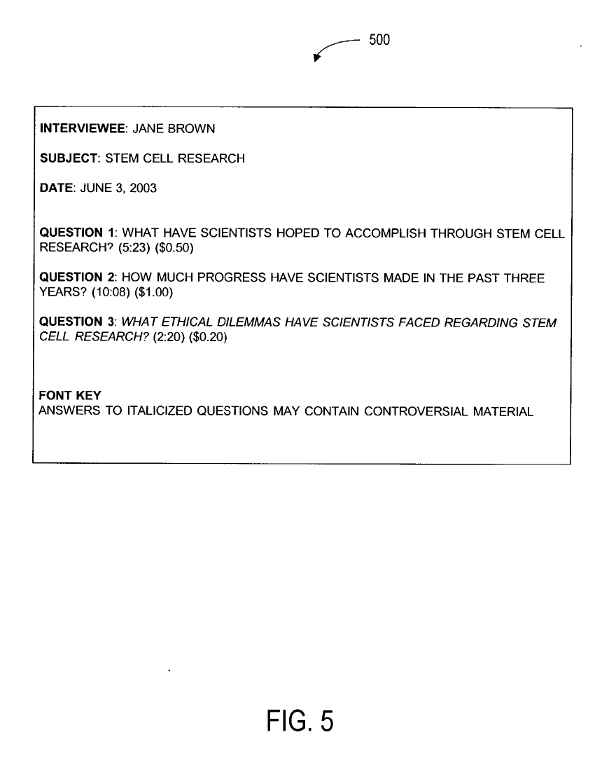

Turning to FIG. 5, an example screen image 500 of a user device 104 illustrating an example Web page view into the controller 102 is provided. The example image 500 displays meta-tags that provide information about an interview of “Jane Brown” regarding “Stem Cell Research” that took place on “Jun. 3, 2003.” Three separate links to three separate answers are displayed as questions. Following each question, a length of time of the response and a price to receive the recording of the response are displayed. By clicking on the questions of interest, a user may be taken to a page in which he may purchase and download the recording for the prescribed price. Note that according to the font key at the bottom of the image, the third question, which is in italics, “may contain controversial material.”

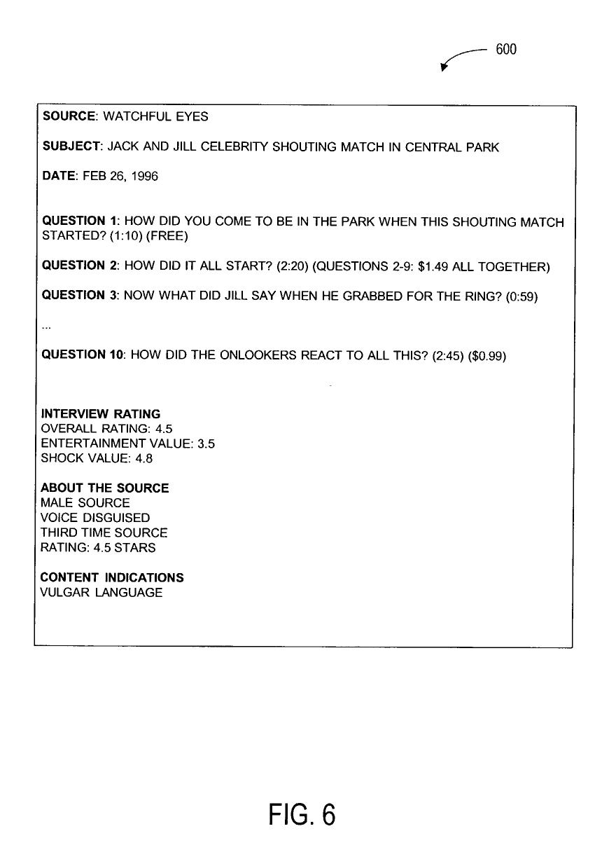

Turning to FIG. 6, a second example screen image 600 of a user device 104 illustrating an example Web page view into the controller 102 is provided. The example image 600 displays information descriptive of an interview available for sale. An interview source named “Watchful Eyes” provided his account of a “Jack and Jill Celebrity shouting match in central park” on “Feb. 26, 1996.” Ten links to the answers to ten questions regarding the event are displayed along with the time of each segment and a price. Note that in this example, the answer to Question 1 is free and the answers to Questions 2 through 9 must all be purchased together. In addition to the links to the answers, rating and other information is provided. Specifically, in this example, an interview rating, source information, and a content indicator are displayed. The interview rating includes an overall rating, an entertainment value, and a shock value. The source information includes the source's gender, the fact that his voice is disguised, the number of times he has been a source, and a rating of his skill as an interviewee. The content indicator conveys that the recording includes vulgar language. Note that the questions displayed on the Web page may not actually be part of the interview. The questions displayed may be created after the sound files of the interview are created and merely serve as an index into the different sub-topics of the interview.

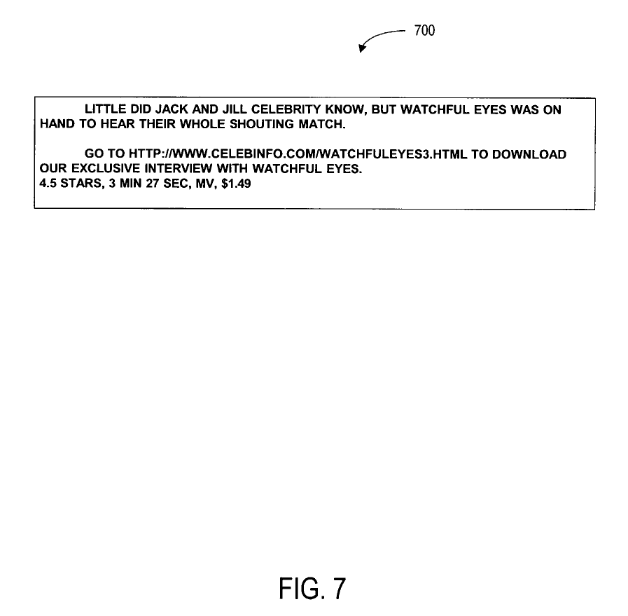

Turning to FIG. 7, an example of a print advertisement including a link leading to the Web page of FIG. 6 is provided. Such an advertisement may appear at the end of a tabloid article. The pictured advertisement reads:

Little did Jack and Jill know, but Watchful Eyes was on hand to hear their whole shouting match.

Go to http://www.celebinfo.com/WatchfulEyes3.html to download our exclusive interview with Watchful Eyes.

4.5 stars, 7 min 27sec, MV, $1.49

Note that the advertisement may be written as if it were part of the tabloid article and appended to the end of the article. Alternatively, the advertisement may appear on an image of the subjects of the interview, for example, on the cover of the tabloid. In some embodiments, the information about the interview may describe only a portion of what is included in the Web site. In some embodiments, the article may be in an online publication and the link may be a hypertext link.

D. Databases

As indicated above, it should be noted that although the example embodiment of FIG. 2 is illustrated to include five particular databases stored in storage device 204, other database arrangements may be used which would still be in keeping with the spirit and scope of the present invention. In other words, the present invention could be implemented using any number of different database files or data structures, as opposed to the five depicted in FIG. 2. Further, the individual database files could be stored on different servers (e.g. located on different storage devices in different geographic locations, such as on a third-party server 110). Likewise, the program 206 could also be located remotely from the storage device 204 and/or on another server. As indicated above, the program 206 includes instructions for retrieving, manipulating, and storing data in the databases 208, 210, 212, 214 as necessary to perform the methods of the invention as described below.

1. Rules of Engagement Database

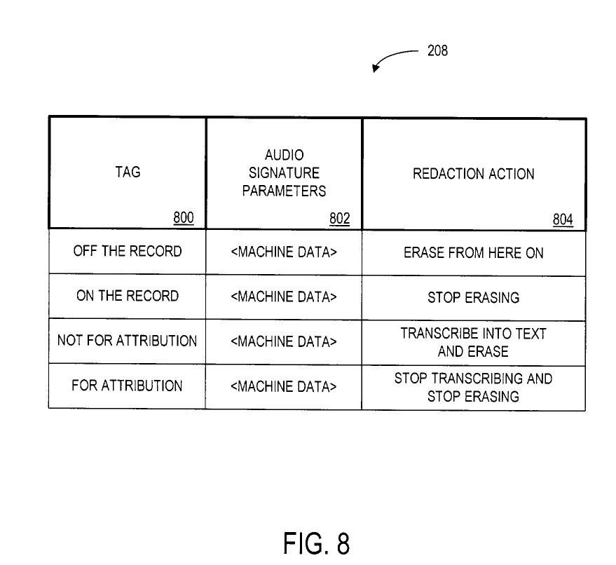

Turning to FIG. 8, a tabular representation of an embodiment of a rules of engagement database 208 according to some embodiments of the present invention is illustrated. This particular tabular representation of a rules of engagement database 208 includes four sample records or entries which each include information regarding a particular rule of engagement. In some embodiments of the invention, a rules of engagement database 208 is used to track such things as tags, data useful for the identification of tags, and redaction rules. Those skilled in the art will understand that such a rules of engagement database 208 may include any number of entries.

The particular tabular representation of a rules of engagement database 208 depicted in FIG. 8 defines a number of fields for each of the entries or records. The fields may include: (i) a tag field 800 that stores a representation uniquely identifying a tag; (ii) an audio signature parameters field 802 that stores a representation of machine data associated with the tag useful for identifying the given tag in an audio recording using pattern matching algorithms; and (iii) a redaction action field 804 that stores a representation of a description of the action that is to be taken in response to the given tag appearing in a recording.

The example rules of engagement database 208 depicted in FIG. 8 provides example data to illustrate the meaning of the information stored in this database embodiment. The information stored in a tag field 800 (e.g. “OFF THE RECORD”, “ON THE RECORD”, “NOT FOR ATTRIBUTION”, “FOR ATTRIBUTION”) may be used to identify the function of the tag. The information stored in audio signature parameters field 802 may be in the form of bit patterns that the redaction program 206 may use to identify tags in the recording. The information stored in the redaction action field 804 (“ERASE FROM HERE ON,” “STOP ERASING,” “TRANSCRIBE INTO TEXT AND ERASE,” “STOP TRANSCRIBING AND STOP ERASING”) includes a directive regarding how the recording should be modified for the associated tag. For example, when “OFF THE RECORD” is detected in a recording, the system 100A, 100B begins erasing the recording from that point forward. Once an “ON THE RECORD” tag is detected, the system 100A, 100B stops erasing the recording from that point forward.

2. Interview Database

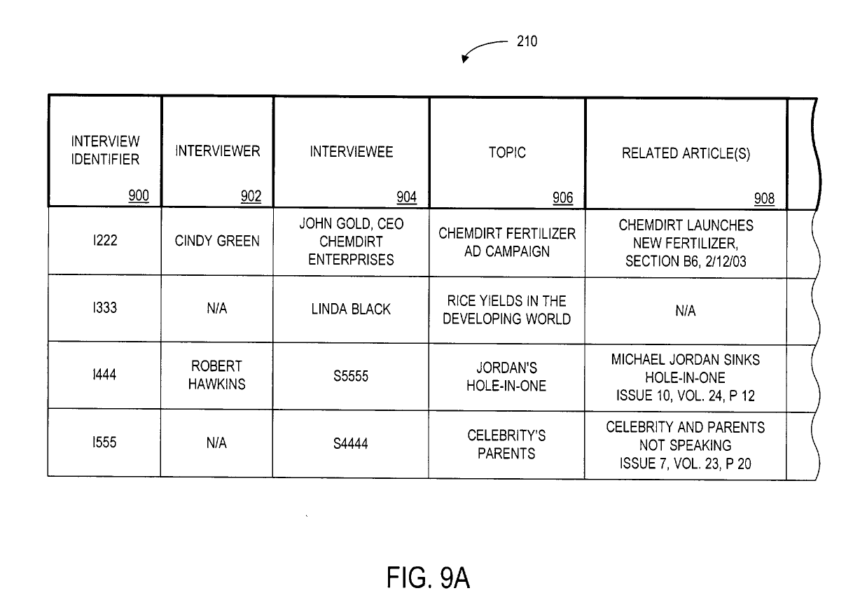

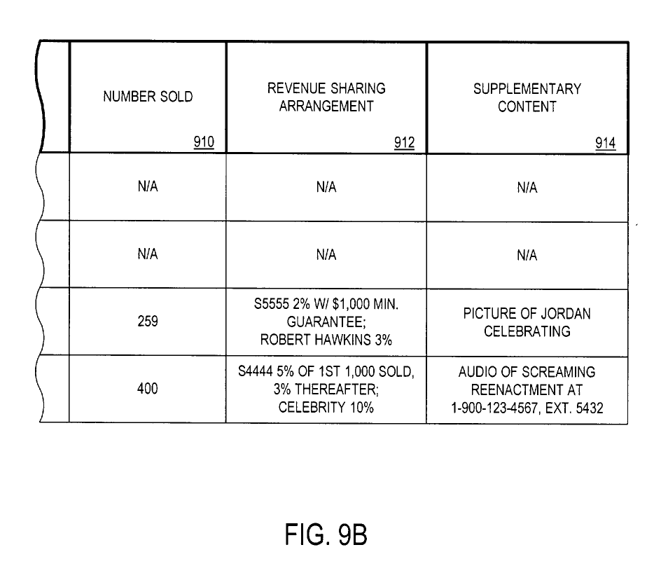

Turning to FIGS. 9A and 9B, a tabular representation of an embodiment of an interview database 210 according to some embodiments of the present invention is illustrated. This particular tabular representation of an interview database 210 includes four sample records or entries which each include information regarding a particular interview. In some embodiments of the invention, an interview database 210 is used to track interview information such as the interviewer's name, the interviewee's name, topics discussed, related articles, sales of the interview, revenue sharing arrangements, and any available supplementary content. Those skilled in the art will understand that such an interview database 210 may include any number of entries.

The particular tabular representation of an interview database 210 depicted in FIGS. 9A and 9B defines a number of fields for each of the entries or records. The fields may include: (i) an interview identifier field 900 that stores a representation uniquely identifying a particular interview; (ii) an interviewer name field 902 that stores a representation of the interviewer's name; (iii) an interviewee name field 904 that stores a representation of the interviewee's name; (iv) a topic field 906 that stores a representation of a description of topic of the interview; (v) a related articles field 908 that stores a representation of a description of articles relevant to the topic and/or interviewee; a number sold field 910 that stores a representation of the number of copies of the interview that have sold; a revenue sharing arrangement field 912 that stores a representation of the compensation agreements relevant to the interview; and a supplementary content field 914 that stores a representation of any additional information available relevant to the interview.

The example interview database 210 of FIGS. 9A and 9B provides example data to illustrate the meaning of the information stored in this database embodiment. An interview identifier 900 (i.e. 1222, 1333, 1444, 1555) may be used to identify and index recorded interviews conducted according to a known set of rules of engagement, for example, those depicted in the example rules of engagement database 208 of FIG. 8.

The first sample entry describes an interviewer named “Cindy Green,” who interviewed “John Gold, CEO, Chemdirt Enterprises.” The topic of the interview is the “Chemdirt Fertilizer Ad Campaign” and a related article entitled “Chemdirt Launches New Fertilizer, section B6, Feb. 12, 2003” is identified. Note that the related article is likely to be the original information product that necessitated the interview of John Gold. In other words, the related article will likely describe the John Gold interview and possibly quote him. However, it is unlikely that the entire contents of the interview could be included in the related article. Thus, the related article may include a fee-based link to the redacted version of the interview for readers willing to purchase more details or possibly purchase a recording of the entire redacted interview.

The second sample entry describes a recording of “Linda Black” talking about “rice yields in the developing world.” No interviewer is identified which may indicate that the recording is of a speech without an interviewer. Likewise the absence of a related article may indicate that no article was or will be written based on Ms. Black's speech. Alternatively, the related article may still be in preparation and just has not been published yet.

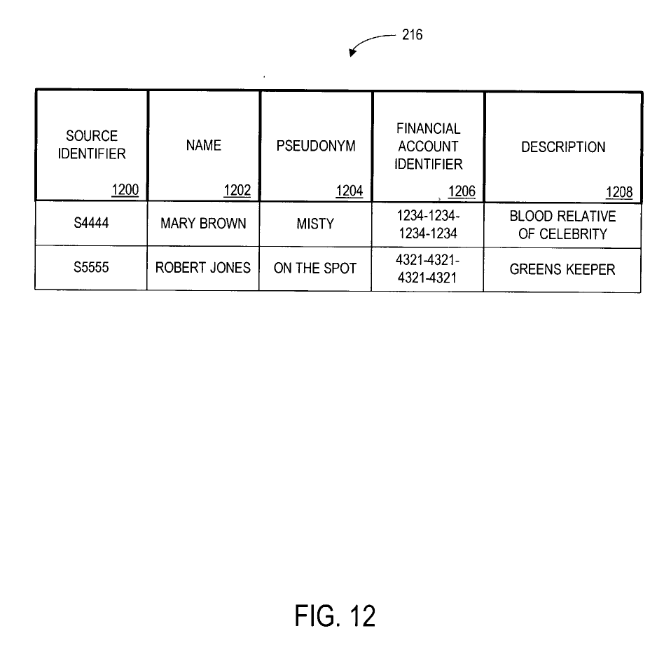

The third example entry describes an interview by “Robert Hawkins” of a source identified by the source identifier “S5555.” (The source identifier serves as an index into the source database 216 discussed below with reference to FIG. 12.) The interview topic is Michael “Jordan's Hole-In-One” and a related article entitled “Michael Jordan Nails Hole-In-One, Issue 10, Vol 24, P12” is identified. “259” copies of the interview have been sold. Source S555 gets 2% of the revenue generated from the interview sales with a guaranteed minimum of $1000.00. The interviewer, Robert Hawkins, gets 3% of the revenue generated from the interview sales. Finally, there is a “picture of Jordan celebrating” also available to accompany the interview. Note that in this example both the interviewee and the interviewer receive compensation for their participation in the interview.

The fourth example entry describes an interview of a source identified by the source identifier “S4444.” The interview is regarding “Celebrity's Parents” and a related article entitled “Celebrity and Parents Not Speaking, Issue 7, Vol 23, P20.” “400” copies of the article have sold and source S4444 is entitled to 5% of the revenue from the first 1000 copies sold and 3% of the revenue from any remaining copies sold. Celebrity gets 10% of all the revenue generated from sales of the interview. Note that in this example embodiment, revenue is shared between the interviewee and a subject of the interview. In addition to the interview, an audio file containing a reenactment of an argument is available via a toll-call 1-900 telephone IVR.

3. Interview Question Database

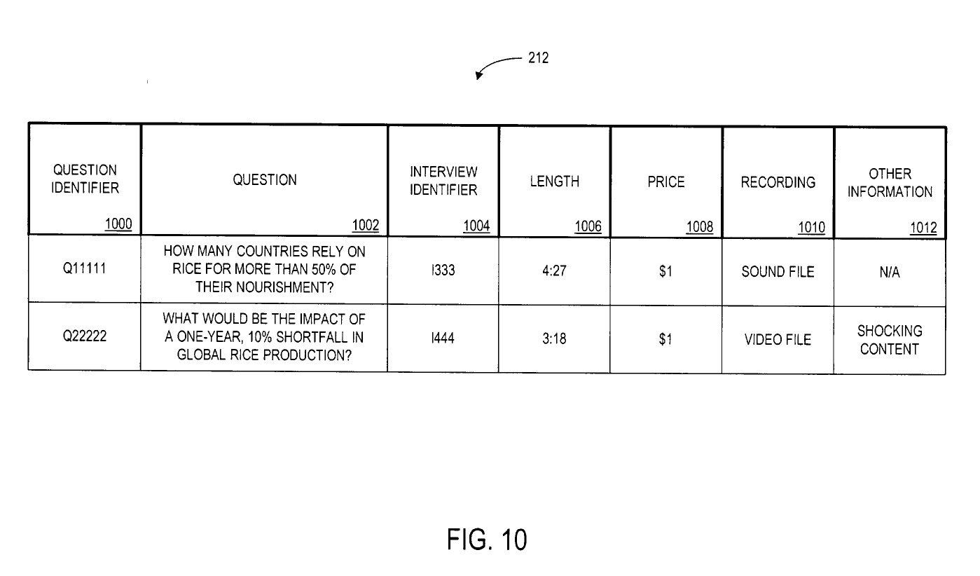

Turning to FIG. 10, a tabular representation of an embodiment of an interview question database 212 according to some embodiments of the present invention is illustrated. This particular tabular representation of an interview question database 212 includes two sample records or entries which each include information regarding a particular interview question. In some embodiments of the invention, an interview question database 212 is used to track information about the interview questions including who asked the question when, the length of the response, the cost to receive a copy of the response, the format of the response, and other information. Those skilled in the art will understand that such an interview question database 212 may include any number of entries.

The particular tabular representation of an interview question database 212 depicted in FIG. 10 defines a number of fields for each of the entries or records. The fields may include: (i) an interview question identifier field 1000 that stores a representation uniquely identifying the interview question; (ii) a question field 1002 that stores a representation of the actual question; (iii) an interview identifier field 1004 that stores a reference back into the interview identifier field 900 of the interview database 210 of FIGS. 9A and 9B; (iv) a length field 1006 that stores a representation of the amount of time of the response; (v) a price field 1008 that stores a representation of the price to receive a copy of the redacted recorded response to the question; (vi) a recording field 1010 that stores a representation of the format of the recording of the response; and (vii) an “other information” field 1012 that stores a representation of descriptive information regarding the response.

The example interview question database 212 of FIG. 10 provides example data to illustrate the meaning of the information stored in this database embodiment. A question identifier 1000 (e.g. Q11111, Q22222) may be used to identify and index the different questions listed in the interview question database 212. The question “How many countries rely on rice for more than 50% of their nourishment?” was posed to Linda Black during interview number “1333.” Her response was “four minutes and twenty-seven seconds” long and it is available for download for “$1.00.” The question “What would be the impact of a one-year 10% shortfall in global rice production?” was posed to an unidentified interviewee and the response, which is “three minutes and eighteen seconds long” and contains “shocking content” is available for purchase in “video” format for “$1.00.” Note that the unidentified interviewee may be intentionally unidentified because the question may have been associated with a “not for attribution” tag.

4. User Database

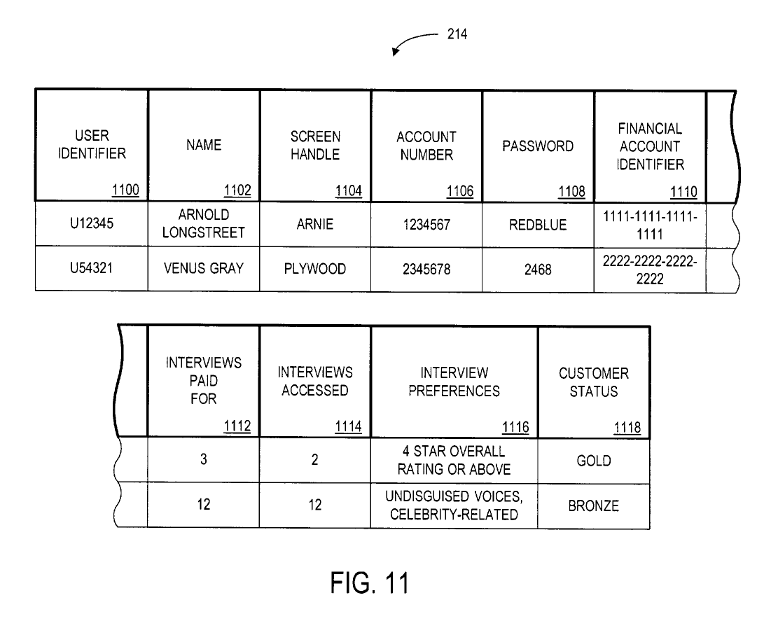

Turning to FIG. 11, a tabular representation of an embodiment of a user database 214 according to some embodiments of the present invention is illustrated. This particular tabular representation of a user database 214 includes two sample records or entries which each include information regarding a particular user. In some embodiments of the invention, a user database 214 is used to track such things as user names, their system account information, their financial account information, their interview purchasing history and preferences, and their status as a customer. Those skilled in the art will understand that a user database 214 may include any number of entries.

The particular tabular representation of a user database 214 depicted in FIG. 11 defines ten fields for each of the entries or records. The fields may include: (i) a user identifier field 1100 that stores a representation uniquely identifying at least one user; (ii) a name field 1102 that stores a representation of the user's name; (iii) a screen handle field 1104 that stores a representation of a unique system user nickname; (iv) an account number field 1106 that stores a representation of a unique number that may be used for billing purposes; (v) a password field 1108 that stores a representation of a user password for securely accessing the system; (vi) a financial account identifier field 1110 that stores a representation of the user's credit card or bank account number; (vii) an interviews paid for field 1112 that stores a representation of a number of interviews purchased by the user; (viii) an interviews accessed field 1114 that stores a representation of a number of interviews reviewed and/or downloaded by the user; (ix) an interview preferences field 1116 that stores a representation of the users preferences regarding interviews; and (x) a customer status field 1118 that stores a representation of a status indicating a level of activity of the user, for example.

The example user database 214 of FIG. 11 provides example data to illustrate the meaning of the information stored in this database embodiment. A user identifier 1100 (e.g. U12345, U54321) may be used to identify and index the different users listed in the user database 214. In the first example entry, “Arnold Longstreet,” screen handle “Arnie,” account number “1234567,” password “REDBLUE,” and credit card number “1111-1111-1111-1111,” has purchased “3” interviews and accessed “2” of them. Mr. Longstreet prefers interviews that have a four star or higher rating and is a “Gold” customer. In the second example entry, “Venus Gray,” screen handle “Plywood,” account number “2345678,” password “02468” and credit card number “2222-2222-2222-2222,” has purchased “12” interviews and accessed all “12” of them. Ms. Gray prefers interviews without disguised voices that are celebrity related and is a “Bronze” customer.

5. Source Database

Turning to FIG. 12, a tabular representation of an embodiment of a source database 216 according to some embodiments of the present invention is illustrated. This particular tabular representation of a source database 216 includes two sample records or entries which each include information regarding a particular interview source or interviewee. In some embodiments of the invention, a source database 216 is used to track such things as source names, their pseudonyms, their financial account information, and a description of the source. Those skilled in the art will understand that a source database 216 may include any number of entries.

The particular tabular representation of a source database 216 depicted in FIG. 12 defines five fields for each of the entries or records. The fields may include: (i) a source identifier field 1200 that stores a representation uniquely identifying at least one source; (ii) a name field 1202 that stores a representation of the source's name; (iii) a pseudonym field 1204 that stores a representation of a unique source pseudonym; (vi) a financial account identifier field 1206 that stores a representation of the source's bank or credit card account number; and (ix) a description field 1208 that stores a representation of a description of the source, for example.

The example source database 216 of FIG. 12 provides example data to illustrate the meaning of the information stored in this database embodiment. A source identifier 1200 (e.g. S4444, S5555) may be used to identify and index the different users listed in the source database 216. In the first example entry, “Mary Brown,” pseudonym “Misty,” and financial account number “1111-1111-1111-1111,” is a “blood relative of Celebrity.” In the second example entry, “Robert Jones,” pseudonym “On The Spot,” and bank account number “2222-2222-2222-2222,” is a greens keeper.

E. Process Descriptions

The system discussed above, including the hardware components and the databases, are useful to perform the methods of the invention. However, it should be understood that not all of the above described components and databases are necessary to perform any of the present invention's methods. In fact, in some embodiments, none of the above described system is required to practice the invention's methods. The system described above is an example of a system that would be useful in practicing the invention's methods. For example, the user database 214 described above is useful for tracking users, but it is not absolutely necessary to have such a database in order to perform the methods of the invention. In some embodiments, the methods described below may be practiced using a conventional customer list.

1. A First Method

Referring to FIG. 13, a flow chart is depicted that represents some embodiments of the present invention that may be performed by the controller 102 (FIGS. 1A and 1B), an external third party, and/or an integrated third party entity/device such as a third-party server 110. It must be understood that the particular arrangement of elements in the flow chart of FIG. 13, as well as the order of example steps of various methods discussed herein, is not meant to imply a fixed order, sequence, and/or timing to the steps; embodiments of the present invention may be practiced in any order, sequence, and/or timing that is practicable.

In general terms and referring to FIG. 13, the method steps of an embodiment of the present invention may be summarized as follows. In Step S1, rules of engagement established by the subjects are received by the system 100A, 100B. In Step S2, an interview of the subjects conducted according to the rules of engagement is recorded. In Step S3, the recording is redacted by the system 100A, 100B. In Step S4, a reviewed version of the redacted recording is received by the system 100A, 100B. In Step S5, a determination is made whether further redaction is necessary: if so, the process loops back to Step S3 where the system 100A, 100B redacts the reviewed recording. Otherwise the process proceeds to Step S6, where meta-tags descriptive of the recording are created, and then to Step S7 where the redacted recording is presented for sale, for example, as displayed in FIG. 5.

In the subsections that follow, each of these seven steps will now be discussed in greater detail. Note that not all seven of these steps are required to perform the method of the present invention and that additional and/or alternative steps are also discussed below. Also note that the above general steps represent features of only some of the embodiments of the present invention and that they may be combined and/or subdivided in any number of different ways so that the method includes more or less actual steps. For example, in some embodiments many additional steps may be added to update and maintain the databases described above, but as indicated, it is not necessary to use the above described databases in all embodiments of the invention. In some embodiments, the methods of the present invention may contain any number of steps that are practicable to implement the processes described herein. The methods of the present invention are now discussed in detail.

(a) Receive The Rules Of Engagement

In Step S1, rules of engagement established by the subjects are provided to the controller 102. If the recording will be of a speech by an individual subject, this step may merely involve defining a few tags to signal the beginning and end of topics. However, in the case of an interview, the interaction between an interviewer and an interviewee may be complicated. The interviewee may have certain points he wishes to get across, and other issues he wishes to avoid. Even when the interviewee wishes that information not be reported, he may be willing to give the information to the interviewer so that the interviewer has some background or perspective. Such information may be signaled using an “off the record” tag. Sometimes, the interviewee may wish to communicate information, but not wish to be reported as the source of the information. Such information may be signaled using a “not for attribution” tag.

The interviewer, on the other hand, typically wants as much information as possible, preferably “on the record”, and wants to be able to disclose his sources to the greatest degree possible. To convince a reluctant interviewee to be somewhat forthcoming, an interviewer may establish an agreement with the interviewee. The interviewer might say, for example, “Just answer the question for my own information, and I promise not to report any of it,” or, “That was good information. I'd like to use some of it. Can you restate your answer in a form that I could use?” Similarly, the interviewee may propose agreements. “I'll answer that, but you must be sure to mention this other point too in your article.” At times, an interviewee might say something he did not intend to say, or may reconsider what he has already said. The interviewee may wish therefore to retract certain statements. The interviewer may allow the statements to be retracted, perhaps, if the interviewee will make an alternate statement on the same subject.

Since there may be a fairly complex interaction between the interviewer and the interviewee, certain rules of engagement may be established prior to the interview. The rules of engagement detail how information obtained in the interview will be used, and how the interviewee may signal this use. In some embodiments, an interviewee signals how information should be used by voicing a phrase, such as “off the record, ” “not for attribution,” or “made a mistake.”According to the rules of engagement agreed to by the interviewer and the interviewee, the interviewer will honor these phrases by, for example, not making certain information publicly available. The precise meanings of these phrases are described in more detail below.

In some embodiments, it is the responsibility of the controller 102 to honor these rules of engagement by, for example, removing certain portions of an audio transcript of an interview. In such embodiments, the controller 102 recognizes signaling phrases and responds appropriately based upon a redaction action associated with each signaling phrase, as, for example, in the rules of engagement database 208 of FIG. 6. Thus, in Step S1 of the present invention, a voice recognition module of the controller 102 may be taught to recognize certain key signaling phrases, called “tags,” in the recording of the interview. A database such as that of FIG. 6 may store sets of parameters corresponding to the audio signature of each potential tag. There are many methods known in the art for determining these parameters and for performing voice recognition. The database may also store instructions for the controller 102 to perform upon it recognizing the tag within the recording.

In some embodiments, the interviewer may repeat a tag after the interviewee has voiced the tag. A voice recognition module may be specifically trained to recognize the interviewer's voice, and so may more accurately identify tags if the interviewer repeats them after the interviewee.

(b) Conduct The Interview

Once the interviewer and the interviewee have agreed on the rules of engagement, in Step S2, the interviewer activates a recording device 106 and begins the interview. During the course of the interview, the interviewer may voice key words or phrases that act as tags for the redacting process. Some possible tags include: question, end question, off the record, on the record, not for attribution, for attribution, etc.

In other words, an interviewer may voice the word “question” prior to asking a distinct question. When the controller 102 executes the redacting and subsequently reviews the recording of the interview, the system 100A, 100B recognizes the word “question” and responsively transcribes the question that follows. The interviewer may also voice the phrase “end question” immediately after asking a question. This allows the redacting process to know when to stop transcribing.

The pair of tags, “off the record” and “on the record”, may be voiced by the interviewer to indicate when the following information may and may not be revealed to the public. Likewise, the pair of tags, “not for attribution” and “for attribution,” may indicate when the following information may and may not be permitted to be attributed to the interviewee.

Although specific tags have been described above, many other words or phrases may be used in their stead. Nonsensical words or phrases may even be used if these are easier for the software to understand. Nonsensical tags have the further advantage of being unlikely to occur during normal conversation. This would reduce the possibility of the redacting software confusing the word “question” for a tag even if the word occurs in normal conversation.

Although verbal tags have been described, other tags are possible. For example, rather than voicing the word “question,” the interviewer may press one of several different tone generating buttons on the recording device prior to asking a question. The recording device may then store a beep or other sound as a tag at that point in the recording. In such an embodiment, the controller 102 would be equipped with the software and data needed to decode the different tones and identify the proper corresponding tags.

In general, tags may be voiced by the interviewer, the interviewee, a third-party, or even a device. As mentioned above, it may be effective for an interviewer to repeat a tag already voiced by an interviewee, because the interviewer's voice is more easily recognizable to the redacting process.

During, or after the interview, the recording may be transferred to the controller 102. In some embodiments, the recording is initially on an audio cassette tape. After the interview, the audio cassette tape may be removed from the recording device 106 and inserted into a tape-playing input component of the controller 102. In other embodiments, the interview may be recorded using a cell phone or other wireless device as the recording device. The cell phone may then transfer the recording, in real time, to a recording component of the controller 102. For example, the interview may be recorded by a cell phone and transmitted into a voice mail box associated with the controller 102.

(c) Perform a Redaction

In Step S3, the redaction process is executed on the controller 102. Unacceptable or inappropriate portions of the recording may be removed from the transcript of the interview so that the recording may be sold to the public. Unacceptable portions of the interview may include parts that were off the record, and parts that were not for attribution. Parts of the interview that suggest that later parts were off the record may also be removed. For example, the interviewer may ask a question, and the interviewee may signal, “off the record,” before answering. If the question remains in the recording, but the answer to the question is removed because of its being tagged as off the record, then there remains the implication to a listener that the question was answered off the record. Thus, the question and the answer may be removed from the recording in the redaction process.

The redaction process may also remove offensive language, redundant language, irrelevant language, excessive pauses, incidental noises, and so on. The redaction process may remove portions of audio where the interviewee has made a misstatement, for example, and wishes such portions to be removed. Redaction may be performed using hardware, software, human operators, or any combination of the three.

A simplified, step by step description of an example redaction process is provided below. This example redaction process transfers data between four distinct memory spaces: Transcript 1 memory, Transcript 2 memory, Phrase memory, and Question memory. As with all systems of the present invention, these four memory spaces maybe implemented using hardware, software, or a combination of both. In this example, Transcript 1 memory is used to store the raw recording, Transcript 2 memory initially starts empty and is used to store the redacted recording as it is created, Phrase memory is used to temporarily store phrases sequentially taken from the raw recording in Transcript 1 memory as they are processed, and Question memory initially starts empty and is used to temporarily store questions until they are appended to Transcript 2 memory at the appropriate time. Once a phrase is loaded into Phrase memory it is analyzed to identify any tags using a voice recognition module. Methods of identifying specific terms in a string of spoken words are well known. For example, see “Speech and Language Processing: An Introduction to Natural Language Processing, Computational Linguistics and Speech Recognition” by Dan Jurafsky et al., published by Prentice Hall; ISBN: 0130950696; (Jan. 18, 2000) which is hereby incorporated by reference. Typically, the contents of Phrase memory will be immediately appended to Transcript 2 memory. However, if the content of Phrase memory is a tag, such as “question” or “off the record”, then the content of Phrase memory is not appended to Transcript 2. Rather, a flag is set or reset in accordance with the tag.

The contents of this Question memory are later appended to the Transcript 2 memory unless the answer to the question is off the record. Otherwise, the contents of the Question memory are discarded.

In addition, this example redaction system and process uses two binary flags. The first flag indicates whether the current portion of a recording in Phrase memory is part of a question or not. A second flag indicates whether the current portion of a recording in Phrase memory is on the record or not. For example, when the system encounters a “question” tag in the recording, then the Question flag is set. When the system encounters an “end question” tag in the recording, the Question flag is reset. While the Question flag is set, the contents of Phrase memory are appended to Question memory rather than to Transcript 2 memory. This is so that the question may later be discarded without being added to transcript 2 if the answer turns out to be “off the record.”

The following “pseudo-code” segment provides an implementation of the example redaction process:

Start:
Clear the contents of Phrase memory
Write the next phrase from Transcript 1 into Phrase memory
Run the contents of Phrase memory through voice recognition module
If the contents of Phrase memory are “question”

Set the Question flag
Go back to Start

If the contents of Phrase memory are “end question”

Reset the Question flag
Clear the contents of Phrase memory
Write the next phrase from Transcript 1 into Phrase memory
Run the contents of Phrase memory through voice recognition module
If the contents of Phrase memory are “off the record”

Clear the contents of Question memory
Set the Off the record flag
Go back to Start

Otherwise (if contents of Phrase memory are anything other than

“off the record”)

Append the contents of Question memory to Transcript 2 memory
Go back to “If the contents of Phrase memory are ‘question’”

If the contents of Phrase memory are “off the record”

Set the Off the record flag
Go back to start

If the contents of Phrase memory are “on the record”

Reset the Off the record flag
Go back to start

If the contents of Phrase memory are “end interview”

End

Otherwise (if the content of Phrase memory is not a tag)

If the Off the record flag is set

Go back to Start

If the Question flag is set

Append the contents of Phrase memory to Question memory.
Go back to Start

Otherwise (if content of Phrase memory is not a tag & no flags are
set),

Append the contents of Phrase memory to Transcript 2 memory
Go back to Start

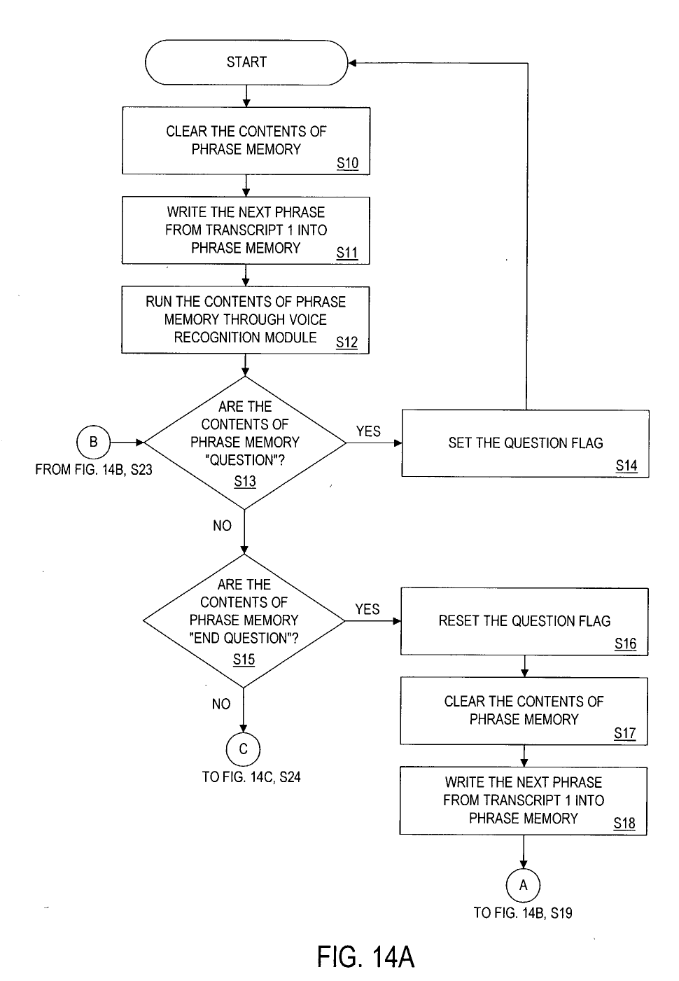

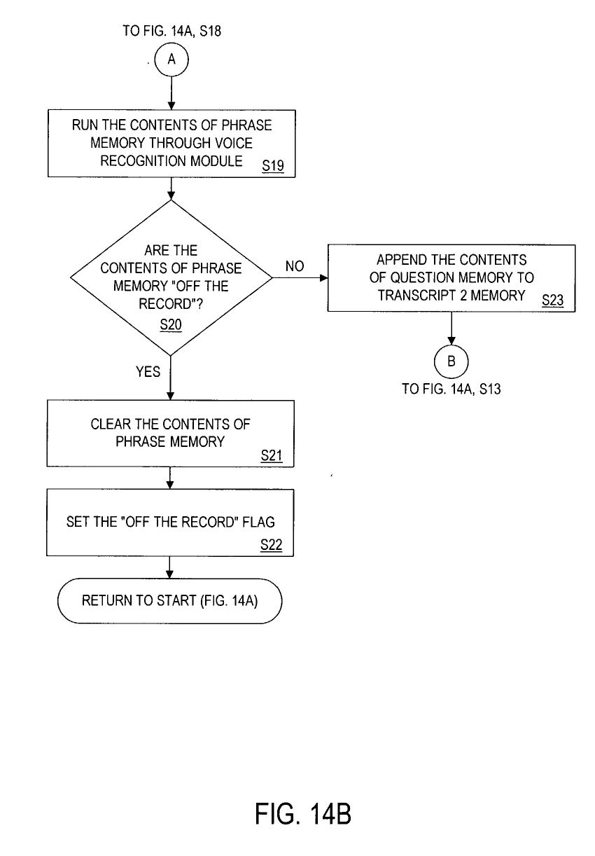

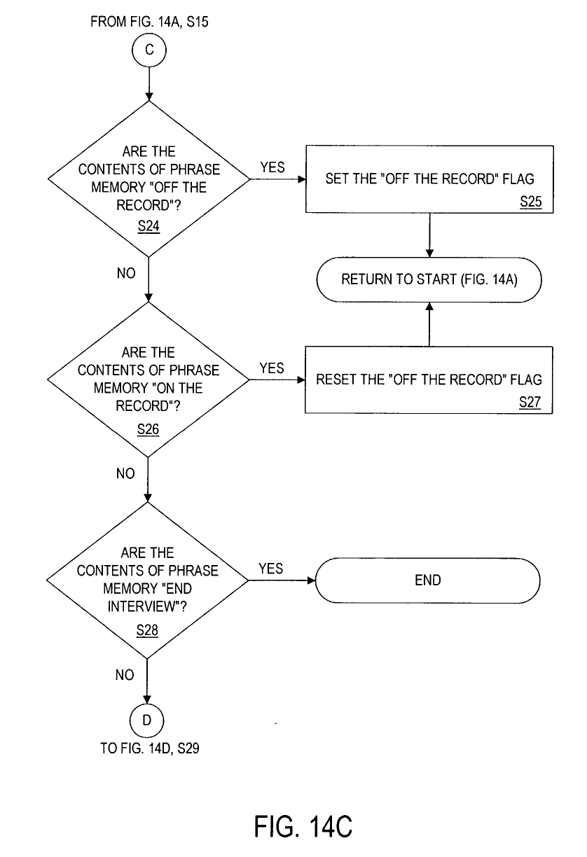

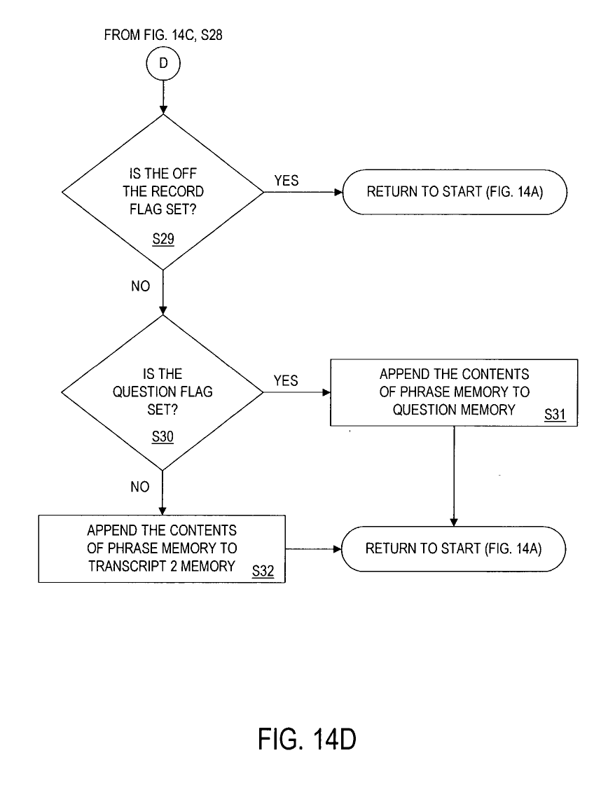

Turning to FIGS. 14A to 14D, the above example redaction process is illustrated in a flow chart. In Step S10, the content of Phrase memory is cleared. In Step S11, the next phrase from Transcript 1 memory is written into Phrase memory. In Step S12, the content of Phrase memory is analyzed using a voice recognition module in an attempt to identify any tags. In Step S13, if the content of Phrase memory is a question tag, then the Question flag is set in S14 and the process returns to Step S10. Otherwise the process proceeds to Step S15 to determine if the contents of Phrase memory are an end question tag. If they are, the Question flag is reset in Step S16, the content of Phrase memory is cleared in Step S17, the next phrase from Transcript 1 memory is transferred into Phrase memory in Step S18, and the content of Phase memory is analyzed using a voice recognition module in an attempt to identify tags in Step S19. If, in Step S20, the content of Phrase memory is an off the record tag, then the contents of Phrase memory are cleared in Step S21, the Off the Record flag is set in Step S22, and the process returns to Step S10. Otherwise if, in Step S20, the content of Phrase memory is not an off the record tag, then the contents of Question memory are appended to Transcript 2 memory in Step S23 and the process returns to Step S13. If in Step S15, the contents of Phrase memory are not an end question tag, the process proceeds to Step S24 to determine if the content of Phrase memory is an off the record tag. If so, then the Off the record flag is set in Step S25 and the process returns to Step S10. If not, then in Step S26, it is determined if the content of Phrase memory is an end interview tag. If it is, then the process has completed. If not, then the process proceeds to Step S29 to determine if the Off the record flag is set. If it is, the process returns to Step S10. If not, a determination is made in Step S30 if the Question flag is set. If it is, the content of Phrase memory is appended to Question memory in Step S31 and the process returns to Step S10. If not, then in Step S32 the contents of Phrase memory are appended to Transcript 2 memory and the process returns to Step S10.

The above example is of a greatly simplified redaction process and system. It does not perform several functions that are disclosed in the present invention. For example, the above description does not eliminate predefined objectionable words from the audio transcript. However, other functions may be readily incorporated into the above example implementation.

(d) Receive a Reviewed Interview Transcript

Returning now to FIG. 13, in Step S4, the system receives back a reviewed recording. Once the redaction has been made, the modified recording may be submitted for review to one or more of the interviewer, the editor of the interviewer's paper, the interviewee, and/or a third party. This review reduces the likelihood that any tags were missed or misinterpreted in the redaction process. In some embodiments of the review process, an editor overlays new tags on top of the redacted recording. If there is a portion of the transcript that should have been left out, then the editor may voice and record the phrase “off the record” at the start of the portion of transcript to be left out. Similarly, the editor may voice and record the phrase “on the record” at the end of the portion of transcript to be left out. The new tags thereby become part of the redacted audio transcript. The editor may choose to overlay new tags on top of the raw transcript rather than the redacted transcript.

In other embodiments of the review process, the editor may manually redact the recording. Once again, this may be the raw transcript or the transcript already redacted by the software. As an example of a manual redaction process, the editor may play the raw audio transcript of the interview using an audio cassette player. At the same time, the editor may record the raw audio transcript onto another audio cassette using an audio cassette recorder. When the audio cassette that is playing reaches a portion of the interview that is off the record, the editor simply stops the recorder from recording. When the audio cassette that is playing then reaches a portion of the interview that is back on the record, the editor begins recording again. Many other methods of manual redaction are possible, and many other systems may be used for such a purpose.

(e) Perform a Second Redaction if Necessary

Once the redacted audio transcript has been reviewed in Step S4, the controller 102 may determine in Step S5 that new tags have been added to the recording and a second redaction should be performed. If the editor has overlaid new tags atop one of the old recordings, then the controller 102 may perform the second redaction just as it did the first. After a second redaction, the editor may review the latest transcript. The process of redaction and review may be repeated any number of times until the editor is satisfied.

(f) Generate Meta-Tags

In Step S6, meta-tags are generated. The term “meta-tag” refers to information about information. The underlying information is the recording of the interview. Information about the recording includes what questions were asked, how long the answers were, who the interviewee was, and so on. These meta-tags give a potential listener information about the interview before he commits money or time to listening to the actual recording. The following exemplary meta-tags may be generated from the recording during and/or after the redaction process:

(i) A textual transcription of a question that was asked by the interviewer. During the redaction process, the redacting system listens for “question” and “end question” tags. The audio that falls in between these tags is transcribed using a voice recognition module. It is not necessary that the textual transcription be perfect. Spelling and grammatical errors may be present. The transcribed question may be stored in an interview question database 212 such as that depicted in FIG. 10. The transcribed text of the question may later be displayed on a Web page hosted by the controller 102. The question may possibly be numbered, indicating how many questions were asked prior to it during the interview. A listener may click on the question in order to hear the response in audio format. In an alternate embodiment, the interviewer or other party may manually key in the question.

(ii) The length of the response to a question. The length may describe the duration of time that the interviewee spoke when answering the question. The length may also describe the number of words used by the interviewee in his response. During the redaction process, the redacting system may track the elapsed time between an “end question” tag and the next “question” tag. The elapsed time then, presumably, measures the length of the interviewee's response. The length of the response may be displayed, for example, next to the textual transcription of the question on the Web site hosted by the controller.

(iii) The price of listening to all or a portion of the interview. In some embodiments, an individual price is listed for the answers to each question in an interview. The price may typically depend on newspaper policy. If there is a predefined per-minute charge for listening, then the redacting software may determine the price of listening to an answer by first determining the length of the answer and then multiplying the length by the per-minute charge. In some embodiments, the price may simply be keyed in manually by an editor.

(iv) The nature of the content. Such a meta-tag may describe the content as vulgar, offensive, mature, graphic, controversial, and so on. During the redaction process, the voice recognition module may recognize key words or phrases from which it may derive an appropriate meta-tag. For example, the redacting software may describe the content of an answer as vulgar if it recognizes certain pre-defined four-letter words. Once again, a meta-tag such as “vulgar” may be displayed next to the textual transcription of a question. The tag may also be manually keyed in by an editor or other party who has listened the interview and made his own determination about the content.

(v) The name of the interviewee. In some embodiments, the interviewer voices the name of the interviewee on the audio transcript of the interview. The redacting software, in conjunction with a voice recognition module, may then transcribe the name and display the name with the interview. Since an interviewee may be sensitive to misspellings of his name, the transcribed name may be compared with a database of interviewee names in order to match the transcribed name with one from the database that is closest in spelling. In other embodiments, an editor or other party may key in the name of the interviewee.

(vi) The name of the interviewer. As with the name of the interviewee, the name of the interviewer may be voiced on the audio transcript of the interview, or may be manually keyed in by the editor. In some embodiments, the redacting software recognizes the source of the audio transcript and thereby recognizes the interviewer. For example, if the interview is recorded using the interviewer's cell phone, and transmitted to the interviewer's voice mailbox, then the redacting software may recognize the interviewer by his voice mailbox.

(vii) The subject of the interview. During the redaction process, the redacting system may pick out key words from the audio transcript and use these to print a subject heading for the interview. For example, the redacting software may pick out the words “education” and “congress” from a transcript and deduce that the subject of the interview is some legislation pertaining to education. More sophisticated methods for determining a subject heading, using artificial intelligence, are also possible. Again, a subject heading may also be keyed in manually.

(viii) The date of the interview. The date of the interview may automatically be incorporated into the audio transcript by the recording device that uses an internal calendar for reference. The redacting software may then recognize the date and create a date meta-tag for the interview.

(ix) A footnote that refers to the interview. The footnote will typically be displayed at the end of a newspaper article that uses a quote from the interview. A typical footnote might read, “For the full audio transcript of the interview with Sam Jones, go to http://www.usatimes.com and type the code ‘b123400.’” A footnote may indicate any of the aforementioned meta-tags, such as the interviewee, the date of the interview, the subject of the interview, etc. The redacting software may communicate footnote information to editing software that assists with the layout of a newspaper. The editing software may then incorporate a the footnote in an article that references the interview.

(x) A note or a hyper-link that refers a listener of a first interview to other related interviews that have been archived. In one embodiment, if the redacting software has the name of the interviewee, then the software may search a database of archived interviews (FIG. 6) for other interviews of the same person. Then, on the Web page displaying information about the current interview, the software may create hyper-links to these related interviews. Many other relationships between current and former interviews are possible, besides having the same interviewee. Many other methods of referring a listener to an archived interview are also possible.

Meta-tags may be spelled out in words or may be presented in the form of colors, symbols, fonts, shading, etc. For example, an interview question whose answer contains graphic content may be transcribed in an italicized font. An interview question on the subject of justice may have a picture of a balance displayed next to the textual transcription of the question. If an answer to a question is both graphic and on the subject of justice, then the question may be presented in italicized form with a picture of a balance displayed alongside.

(g) Present the Interview

Once the transcript of the interview has been redacted, reviewed, and all appropriate meta-tags have been generated, the interview transcript is made available to the public in Step S7. In some embodiments, meta-tags of the interview are posted on a Web site hosted by the controller 102. A potential listener may then access the interview using a browser such as Internet Explorer®. A potential listener may click on the meta-tags consisting of textual transcriptions of the interview questions. By clicking, the listener may activate an audio sound file containing a portion of the final transcript of the interview, and may thereby listen to the answer to the displayed question.

The listener may also be required to pay before listening to a portion of the interview. Clicking a meta-tag may bring the listener to a Web page where he may enter his credit card number and agree to pay the price of listening. The identities of paid listeners may be stored in user database 214 of FIG. 11, along with their financial account identifiers. Then, listeners who have already entered a credit card number need not do so a second time. Instead they may be given a password to use when paying to listen to interviews.

2. A Second Method

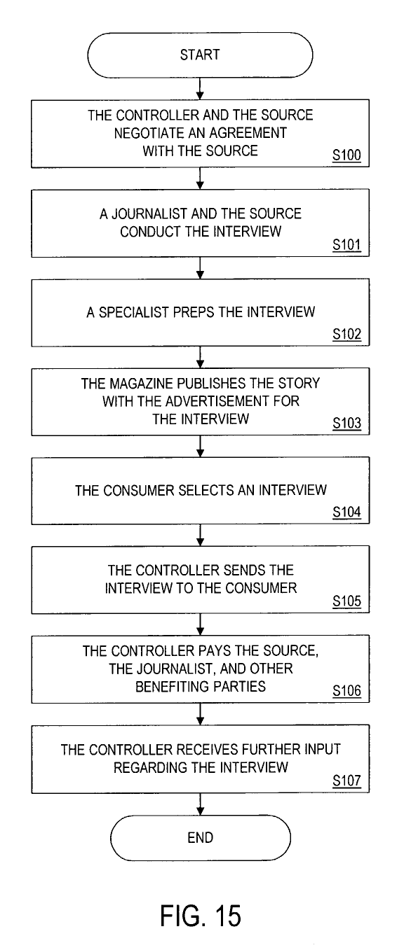

Referring to FIG. 15, a flow chart is depicted that represents some embodiments of the present invention that may be performed by the controller 102 (FIGS. 1 A and 1B), an external third party, and/or an integrated third party entity/device such as a third-party server 110. It must be understood that the particular arrangement of elements in the flow chart of FIG. 15, as well as the order of example steps of various methods discussed herein, is not meant to imply a fixed order, sequence, and/or timing to the steps; embodiments of the present invention may be practiced in any order, sequence, and/or timing that is practicable.

In general terms and referring to FIG. 15, the method steps of an embodiment of the present invention may be summarized as follows. In Step S100, the controller 102 and the source negotiate an agreement with the source. In Step S101, a journalist and the source conduct the interview. In Step S102, a specialist processes the interview. In Step S103, the controller 102 publishes the story with an advertisement for the interview. In Step S104, a consumer selects an interview. In Step S105, the controller 102 sends the interview to the consumer. In Step S106, The controller 102 pays the source, the journalist, and other benefiting parties. In Step S107, the controller 102 receives further input regarding the interview.

In the subsections that follow, each of these eight steps will now be discussed in greater detail. Note that not all eight of these steps are required to perform the method of the present invention and that additional and/or alternative steps are also discussed below. Also note that the above general steps represent features of only some of the embodiments of the present invention and that they may be combined and/or subdivided in any number of different ways so that the method includes more or less actual steps. For example, in some embodiments many additional steps may be added to update and maintain the databases described above, but as indicated, it is not necessary to use the above described databases in all embodiments of the invention. In some embodiments, the methods of the present invention may contain any number of steps that are practicable to implement the processes described herein.

(a) In Step S100, the Controller 102 and the Source Negotiate an Agreement with the Source

In some embodiments, a source contacts the controller 102 so as to convey his story. However, before the source discloses his story, an agreement may be worked out between the source and the controller. This agreement may address how the source will be compensated, how or if the source's identity will be concealed, and the rules of engagement that will be employed during the interview.

(i) The source contacts the controller. The source may contact the controller 102 in several different ways. Contact may be made by email, by phone, by filling in a Web form, by fax, by postal mail, or by any other means. In many cases, the source does not achieve immediate contact with a journalist, but must instead leave a message previewing the story he has to tell, along with contact information. For example, a source might fill in a Web form on the controller's 102 Web site indicating that she is a relative of Celebrity and has information about an argument between Celebrity and his parents. She may also leave a phone number. If a journalist or other controller 102 representative is later interested in hearing the full story, the journalist may contact the source.

The controller 102 might have standardized and possibly detailed forms or instructions for potential sources to use when leaving messages. For example, a voice response unit (VRU) may ask specifically for a name, a phone number, a one-minute summary of a story, whether there are any corroborating sources, and so on.

(ii) In some embodiments, the source and the controller 102 may next agree on compensation for the source. Compensation for the source may take a number of different forms, including for example, any combination of the following: a monetary percentage of sales or profit related to the source's story; a fixed cash payment; a non-monetary reward that depends on sales or profit related to the story; a donation to charity on behalf of the source; and recognition for the source.

There are many possible variations on how compensation may be given. For example, a source may receive 5% of revenue from the sale of his story for the first 1000 stories sold. He may then receive 3% of sales for every subsequent story sold. In another example, a source may receive 85% of revenue from sales of his story within the first week after it is broken, but may receive only 1% thereafter. In another example, a source may receive an upfront payment against future royalties or a flat payment if sales exceed 100,000 copies.

A non-monetary payment may be a product such as a color TV, an expense paid vacation, or a service such as a haircut at a famous salon. A story that sells to 1000 consumers might earn the source a stereo, while a story that sells to 10,000 consumers might earn the source a motorized scooter. Non-monetary payments may be important because sources may often be uncomfortable accepting money for their information. In some cases, for example, a source may be breaking a story about a friend or relative because the source desires that the friend seek help for a drug problem or other malady. A source may not want to accept money for exposing a friend. In other circumstances, a source may not want money because he feels it might leave a trail by which his identity could be more easily discovered.

In some embodiments, the source's compensation agreement may specify that the amount of compensation depends on the types of consumers who buy his story. For example, if the buying consumers include a new demographic for a publication associated with or operating the controller 102, then the source may receive more valuable compensation than he would otherwise.

In some embodiments, compensation may be given to the source for subsequent stories that result from or follow on from his story. For example, a source might uncover an embarrassing new story about a politician who had previously been thought of as a model of civility and morality. For his story, the source might receive 5% of all sales. However, the source might also receive 2% of sales for subsequent stories, by other sources, that reveal further details of the politician's misstep.

In some embodiments, a source may be compensated based on consumers' reactions to his story. If consumers give a low rating to the story's entertainment or other value, then the source may receive correspondingly low compensation.

In some embodiments, a source may receive recognition by having his interview advertised prominently in the publication associated with the controller 102. For extra recognition, the source's interview may be advertised next to subsequent stories that may or may not be related to his. Recognition may come from revealing the source's identity, or from providing the source with a special reserved pseudonym such, as for example, “The Teller.” A Web site hosted by the controller 102 may feature a biography of the source with or without revealing his identity. The Web site may include a picture with the face hidden. Many other modes of recognition are possible.

Additional clauses may apply to the compensation agreement between the source and the controller 102. In some embodiments for example, the controller 102 may reserve the right with the source to give away the interview for free. Giving away the interview might accomplish promotional goals. If the story is given away, the source may receive no compensation, at least in relation to the customers who obtained the story for free. The source may still share a percentage of the profits from other interviews sold.

(iii) In some embodiments, the source and the controller 102 agree on a degree of identity shielding. A source may have a number of reasons for keeping his identity hidden. By revealing information, the source may betray the trust of a friend or relative, or other acquaintance. The source may not wish to be known as a gossip or an opportunist. The source may simply not wish to be famous.

The controller 102 also may have reasons for hiding a source's identity. Hiding the identity makes it harder for competing publications to use the source for their own stories. Hiding the identity may boost sales when the source, if known, would be thought by the public to be boring. Hiding the identity may also lend an air of mystery to the story. The publication associated with the controller 102 may obtain further revenue, in some embodiments, from first hiding the identity and then revealing it for a fee.

In some embodiments, the source's voice may be disguised on the audio transcript of the interview. The voice may be disguised to varying degrees. For example, the disguise might hide unique identifying characteristics of the source's voice, but may not hide a particular accent, the gender of the source, the age range of the source, and so on. In general, any combination of the aforementioned and other voice characteristics may be hidden or revealed in the audio transcript of the interview.

In some embodiments, an actor's voice or a computer-synthesized voice may be substituted for the source's voice. In other embodiments, the source's voice may be left intact, but the source may simply not be identified.

In some embodiments, the source's identity may be selectively revealed to a subset of consumers. This might occur, for example, if a source is concerned only about certain people, such as neighbors, finding out his identity. If neighbors are of concern, a source's identity might be revealed only to those living outside of the source's geographic region. Thus, for example, consumers calling from a particular area code to listen to the interview may not be told the identity of the source and consumers calling from other area codes may be told. In some embodiments, an identity may also be revealed only to privileged customers of the publication, for example, customers with special customer status such as a “five-year subscriber.” Other groups from which an identity may be hidden or disclosed include first time customers of the publication, long time customer of the publication, professionals, men or women, subscribers to the publication, non-subscribers, and so on. In addition, an identity may be hidden from particular individuals, identified by name, customer account number, credit card number, etc.

Often, magazines and other publications have high standards of accuracy for publishing a story, especially if the story is potentially embarrassing or critical of the subject. This is because magazines may lose readers' trust or be subject to litigation after publishing inaccurate stories. Therefore, in some embodiments, a journalist may require the potential source to provide information regarding corroborating sources. The journalist might later wish to interview the corroborating sources in order to verify the accuracy of the story.

In some embodiments, it may also be necessary to provide compensation to the corroborating sources in exchange for their information. When the journalist and the first source discuss the terms of the compensation agreement, the journalist may ask the source what the corroborating sources would need to be paid. In some embodiments, the journalist might offer compensation to the first source that is to be divided up amongst all the other sources as the first source sees fit. In such an embodiment, it would be up to the first source to convince the others to come forward, using the compensation provided by the journalist as an incentive for the other sources. Alternatively, the journalist might negotiate compensation and other terms on an individual basis with the corroborating sources. In some embodiments, the amount of compensation promised or provided to any one source may be conditioned on the cooperation of other sources. For example, a first source may be offered 5% of the revenue from sales of his story if he is able to get a second source to provide information to the controller 102. However, if the second source does not provide information, the whole story may not be viable, and the first source may get nothing.

(iv)In some embodiments, the source and the journalist agree on the use of rules of engagement. As discussed in detail above, the rules of engagement describe how the journalist may use information he obtains in the interview, and how the source should signal this use. For example, as part of the rules of engagement, the journalist may not make certain information available to the public. The source may signal what information should not be made publicly available by saying, “off the record.” The source may also signal that parts of the interview are not to be attributed to him, that parts of the interview are to serve only as background information, that previous statements made by the source are to be excluded, etc. For all of these, rules, there may exist signaling phrases such as, “not for attribution,” “background,” or “made a mistake.” For each signal, there may be an opposite. Thus, the phrase “on the record” may signify that after a period of not being able to use information from the interview, the journalist may now use subsequent information.

When the source gives certain signals, as by saying “off the record,” the journalist may repeat the signals. The repetition may ensure that an editor of the interview is less likely to miss the signal in a recording. Also, as in the embodiments described above, modification of the interview may later be performed by software that automatically recognizes signals. The software might be trained to recognize the journalist's voice, making it prudent for the journalist to repeat any signals from the source. Note that in some embodiments, it is not necessary that the interview be conducted based upon any predefined protocol such as a rules of engagement system as described herein. In some embodiments of the present invention, raw transcripts may be used, or in others, transcripts may be edited using conventional methods that do not require tags.

In some embodiments, once the source and the journalist have negotiated and discussed the terms of their agreement, the terms may be summarized and the source may signal his agreement. For example, if the source and the journalist are speaking over the phone, then the journalist may read off the terms of the agreement and ask that the source say, “I agree,” and then say his [the source's] name. The source's utterance may be recorded by the controller 102 as a record of the source's agreement. The source may also sign a written document and fax or mail it back to the controller 102. The source may digitally sign an electronic document by, for example, encrypting the document with a private key such that only the source's public key would decrypt the document. Many other ways of signaling agreement are possible.

(b) In Step S101, a Journalist and the Source Conduct the Interview

Once an agreement has been reached, the journalist may interview the source. The interview may be conducted over the phone, in person, via email, via AOL Instant Messenger® or by any other means. In some embodiments, a phone interview may be recorded by a recording device 106. For example, the journalist may put the phone in a speaker mode and place an audio cassette tape recorder by the phone in order to record the interview.

As the interview is conducted, the source's voice may be disguised. For example, the journalist's phone may contain a filtering circuit that filters the electronic signal representing the source's voice. The filtering circuit may be any digital or analog filter as is commonly known in the art. Many well known filters reduce the presence of certain frequencies in a signal. Thus, the higher tones from a person's voice might be eliminated or drastically reduced, thereby disguising the voice. Many other filtration methods are possible.

Once the electronic signal has passed through the filter, the phone may convert the electronic signal to sound using a speaker. The sound might then be recorded by the tape recorder. This method of disguising the source's voice would have the advantage of leaving the journalist's voice intact, since the journalist's voice would not be passing through the phone or the filter contained therein. A further advantage of this method would be that the only recording of the interview would have the source's voice disguised. As a result, the source may gain a higher level of confidence about the ability of the journalist to shield the source's identity. An alternative method would involve first recording the interview without disguising any voices, and then applying a filter to the recorded interview. However, this alternative would make it more complicated to avoid disguising the journalist's voice while still disguising the source's voice.

In some embodiments, both the source and the journalist's voices are converted to electronic signals before being recorded. For example, the source at a first location and the journalist at a second location might be in conference with the recording device at a third location. In such an embodiment, the journalist or another party may selectively apply a filter to the conversation taking place in the interview. For example, the journalist may depress a button to apply the electronic filter when the source will speak, and release the button before the journalist speaks.

In some embodiments, the interview may be conducted according to the rules of engagement. The journalist, or another party, may honor signals during the course of the interview. For example, when the source says, “off the record,” the journalist may stop recording the interview. When the source later says, “on the record,” the journalist may resume recording. On the other hand, the source's signals may be honored after the interview is over by retroactively processing the interview.

(c) In Step S102, a Specialist Preps the Interview

In some embodiments, once a transcript of the interview has been recorded, a specialist may comb through the transcript and modify it to a form suitable for sale to the public. If there are rules of engagement, the specialist honors the rules by eliminating portions of the interview transcript that were off the record, and possibly by eliminating portions of the interview the source described as misstatements. Where portions of the interview were not for attribution, the specialist may rephrase them and communicate them in a different voice. There are many other possible ways of communicating information without attributing it to the source.

The specialist may also insure that the source's voice is adequately disguised in accordance with any agreement made with the source. To disguise the source's voice, the specialist may convert the audio transcript into electronic signals and pass portions of the interview through an electronic filter. In some embodiments, the specialist may disguise the source's voice, but keep the journalist's voice undisguised.

In some embodiments, the specialist also may improve the entertainment quality of the interview transcript by eliminating verbal crutches, such as “um's” and “ah's,” by eliminating excessive pauses, by eliminating repetitive information, and so on. The specialist may also speed up the interview transcript by, for example, having it played at a faster speed than that at which it was recorded. Similarly, the specialist may have the interview slowed down. When the interview is sped up or slowed down, the specialist may employ various signal-processing algorithms known in the art to keep voices at their natural pitches.

In some embodiments, the specialist may remove portions of the interview with content satisfying various criteria. For example, vulgar, mature, hateful, inflammatory, controversial, malicious, sadistic, confidential, and/or slanderous content may be eliminated. In some cases, statements that cannot be true or cannot be verified may be eliminated. Many other criteria are possible for elimination. To eliminate content, the specialist may overlay a tone, may cut out the content entirely, or may replace the content with a substitute, such as a euphemism for a word actually used. Many other ways are possible for eliminating content. In some embodiments, it will not be necessary to eliminate content. For example, a sports coach giving commentary on the strategy used in a game likely will not use any objectionable words or phrases.

In some embodiments, once the specialist has made his modifications to the interview, the modified interview transcript may be sent to the source for review. The source might confirm, for example, that the portions of the interview he intended to be off the record were in fact eliminated. The interview transcript may be reviewed by others, such as an editor or a focus group of consumers who give their feedback on the interview's salability. The interview transcript may be reviewed by a friend of the source's to see whether the friend can recognize the source's voice on the interview transcript.

(d) In Step S103, the Controller 102 Publishes the Story with the Advertisement for the Interview

In some embodiments, a prepped interview may be made available to the public. To access the interview, a consumer may ultimately receive a sound file, such as an MP3, at a user device 104. In some embodiments, a consumer might also make a phone call to a particular number so as to access a recording of the interview. As another alternative, a consumer may obtain a text-based transcript of the interview by email, fax, or postal mail.

In some embodiments, a consumer may become aware of an interview by reading a story that resulted from or is supported by the interview. For example, a consumer first reads a story about a celebrity saving the life of a child. After reading the story, the consumer is directed to the interview that first broke the story. In this example, the interview may be with the parents of the child.

In some embodiments, to advertise the interview, the controller's associated publication may publish an advertisement in proximity to a related story. The advertisement may direct a reader as to how he might access the interview. The advertisement may include, for example, a phone number to call to listen to the interview, a Web site to visit to download the interview video file, and/or a Web site to visit to read the text of the interview. In some embodiments, a single advertisement might advertise multiple interviews. Any or all might be related to the story, or all may not be. In some embodiments, the advertisement might read like a continuation of the story. An exemplary advertisement is depicted in FIG. 7.

In some embodiments, there may not be enough space in an advertisement to promote all interviews available related to a story. To accommodate these extra interviews, an advertisement might instead promote another medium for viewing the additional interviews. For example, an advertisement might say: “To learn about ten additional interviews casting serious doubt on Henry Jones's alibi, go to http://www.insidescoop.com/HenryJones.html. Rather than a Web site, a consumer might be directed to another page of the publication, a different publication, or a phone number.

In some embodiments, a publication with multiple stories may contain promotions for dozens or hundreds of interviews. As such, the publication may publish an index of all available interviews. For example, the index may cover a single issue, a particular time period, a particular subject, a particular source, and so on. The index may be published in each issue of the publication, in a supplemental issue, in a certain issue every year, etc. The index may provide a customer with a convenient means for finding interviews with particular characteristics. In addition to searching for interviews by time, subject, and source, a consumer might search by interview rating, by source rating, by the gender of the source, by the relationship of the source to the subject of the interview, etc.

Both in advertisements and in indexes, in some embodiments, promotions for interviews may contain a special nomenclature describing characteristics of the interview or of the source. The nomenclature may allow the promotions to convey high information content in a relatively limited space. For example, an “M” might represent “male source,” and “F” may represent “female source.” A numeral “2” might indicate that this is the second interview given by the source. In some embodiments, the content of the interview may have such indicators as “V” for “violent,” “A” for “adult,” or “C” for “crude.” Symbols might be used in place of letters. For example, a bullet shaped symbol might indicate violent content, with multiple bullets indicating a higher degree of violence. Font size variation, italicization, bold facing, underlining, shading, coloring, and other text modifications may all provide information about an interview. The rating of an interview may be indicated by text or other symbols, such as stars. A highly rated interview may receive multiple stars. Different symbols may correspond to ratings along different scales. For example, stars might indicate the rating of the interview, while lip-symbols might indicate the rating of the source.

Many other rating scales may apply to an interview. The interview may be rated for entertainment value, shock value, educational value, embarrassment value, and so on. Using the nomenclature and different rating scales, a consumer might more easily find interviews suitable to his taste. For example, a consumer might prefer only interviews with female sources, or may prefer to listen only to highly rated sources. A consumer might also wish to avoid sources participating in an interview for the first time.

In some embodiments, a promotion may contain the source's identity or at least some identifying or descriptive information pertaining to the source. In some embodiments, the source may instead be identified by a pseudonym. The journalist's identity may also be given.

In some embodiments, publications may be paid by third parties to publish advertisements or entire promotions for interviews. This may occur when the third party is to derive some or all of the revenue from the sale of the interviews to the public. The third party may pay the publication to publish a predetermined number of advertisements, to use a predetermined amount of space for one or more of the advertisements, to promote a predetermined number of interviews, to use a predetermined amount of space per story for ads, to promote a predetermined number of interviews per story, etc. The payment, for example, may take the form of a fixed sum, a guarantee of a percentage of revenues or profits derived from sales of the interview, and/or any combination of the two.

In some embodiments, the controller 102 may receive revenue derived from sales of the interview, and may be guaranteed a certain minimum amount of revenue by a third party. For example, the controller 102 may purchase, from the third party, technology or services for selling interviews via a third-party server 110. As part of such a purchase, the third party may guarantee for example, that the controller 102 will earn $2 million in profits the first year from selling interviews. Then, if the controller 102 earns less the first year, the third party may pay the controller 102 the difference. In some embodiments, the controller 102 may be required to follow specified procedures so as to ensure reasonable efforts are made to achieve the guaranteed profit threshold before being paid the difference.

In addition to, or instead of, guaranteeing an amount of sales or profits, the third party may guarantee the controller 102 a minimum amount of advertising revenue to be derived from the advertisements promoting interviews. The guarantees allow a controller 102 to significantly change its practices by promoting interviews associated with stories, without the risk of losing too much money during the transition. For example, a controller 102 that informs a major advertising customer that the advertiser may not have as much space as usual because the controller 102 is going to use the space to promote interviews, faces the risk of loss of significant advertising revenue. In the present invention, this potential loss may be offset by the guarantee of advertising revenue or sales revenue resulting from the promotion of interviews.

(e) In Step S104, the Consumer Selects an Interview

To select an interview to which to listen, a consumer may visit the Web site indicated in the interview's promotion in some embodiments. At the Web site, the consumer may enter a mode of payment, and an address to which the interview might be sent. The consumer might also enter identifying information such as a name, age, occupation, and so on. The identifying information may allow the controller 102 to maintain a profile of the consumer in, for example, a user database 214 and to alert the user of other interviews that might be of interest for the user. The consumer selects the interview by, for example, clicking on a box next to a description of his desired interview.

In some embodiments, the consumer may enter a credit card or debit card number as a mode of payment. The consumer may alternatively enter a special code allowing him to listen to an interview for free or for a discount. The code may be some sequence of alphanumeric symbols, for example. Codes might be given out to consumers to encourage them to try listening to interviews with the hope that they would subsequently purchase more interviews in the future. Codes may be sent to consumers via postal mail, email, or any other practicable method. Codes may also be printed on or enclosed within magazines purchased by consumers. Many other types of codes are possible, and many other means of distributing such codes to consumers are possible.

In some embodiments, a consumer need not pay individually for every interview. A consumer may instead pay to listen to a fixed number of interviews, to all interviews falling within a certain time period, to all interviews relating to a particular story or person, to all interviews given by a particular source, etc. A consumer might pay to listen to interviews on a periodic basis. For example, ten dollars might buy a consumer a license to access exactly one new interview every week for a year. In some embodiments, a consumer may purchase a subscription to all interviews regarding a particular topic, person, etc.

In embodiments where a consumer does not pay for interviews on an individual basis, then he need not enter a credit card number each time he wishes to access a new interview. Instead, he may be provided with a user account with a screen handle and a password. The user might then log into his account and listen to any interviews entitled him by a prior payment or by his guarantee of a future payment. In some embodiments, the user's credit card number may be associated with the user's account. Any time the user logs in and accesses an interview, his credit card may be charged automatically.

In some embodiments, a consumer may select an interview over the phone rather than over the Internet. The consumer may call up a VRU and respond to commands such as, “key in your name,” or, “key in your credit card number.” If the consumer already has a credit card number on file with the controller, then he may need only key in a screen name and password. In some embodiments, the controller 102 may recognize the consumer using Caller-ID^{SM} simply by looking up the number from which the consumer called in the user database 214. In some embodiments, the consumer may also speak information into the phone. The controller 102 may then use voice recognition technology or customer service representatives to take down the consumer's information.

There are many ways a consumer might select an interview. At the controller's Web site, descriptive information about interviews may be listed. Descriptive information might include the subject, title, source, date of the interview, magazine issue in which the interview was advertised, etc. Information contained in an advertisement for the interview may be displayed using special nomenclature, or may be displayed on the Web in full English. For example, an “M” in an advertisement might become “Male” on a Web version of the advertisement since there is more space available on the Web. At the Web site, the user might click a box, a hyper-link, or any other indicator so as to select an interview. The user might also key in descriptive information about an interview in order to select it.

In some embodiments, each interview may be associated with a code that may be printed in the ad promoting the interview. The consumer might then key in the interview's code in order to select the desired interview.

In some embodiments, the controller's Web site may index interviews in various ways so as to allow a consumer to more easily find an interview of interest. The interviews may be indexed by subject, title, source, date of the interview, magazine issue in which the interview was advertised, rating of the interview, rating of the source, content of the interview, degree of identity shielding of the source, etc. The Web site may also contain a search feature allowing a user to type in key words to be found in a title, subject, etc.

In some embodiments, a similar selection process might apply over the phone as a consumer interacts with a VRU associated with the controller 102. The VRU might play voice recordings of several interview descriptions, and allow the consumer to press a number corresponding to the consumer's desired selection. The consumer might also have the opportunity to press a key combination on his dial pad corresponding to a code associated with an interview. A consumer may select an interview while speaking to a live customer service representative. A consumer might also speak his selection to the VRU, which might use voice recognition technology to interpret the consumer's speech. Many other methods of selecting an interview are possible. For example, a consumer might indicate a selection by fax, email or postal mail.

Once a particular interview is selected, a consumer may be presented with the additional option of selecting portions of the interview to which to listen and to which not to listen. For example, the consumer may choose to listen to the first or last three minutes of the interview or the consumer may choose to listen to answers to particular questions asked in the interview. The controller 102 may also have created different versions of an interview from which the consumer might choose. For example, one version might be unedited, another might have repetitive content eliminated, another might have vulgar content eliminated, another might be condensed, and so on. Some versions of an interview may differ in the degree to which the source's identity is hidden. The consumer might choose from any one of these versions. Of course, the price of listening may differ depending on which portion or which version of an interview a consumer selects. For example, a consumer might pay more to listen to a version of an interview where the source's identity is revealed than to a version where it is not. An example of a Web page that provides consumers with choices regarding an interview is illustrating in FIG. 6.

In addition to selecting individual interviews to which to listen, a consumer might select deals or promotions allowing him to receive special pricing rates on one or more interviews. For example, the consumer might buy a “subscription” to interviews whereby he might be allowed to listen to one interview per week for ten weeks at a per interview price of $0.50 cents rather than the usual dollar. In some embodiments, a consumer may select deals such as “three for the price of one,” or “buy ten interviews and get the eleventh for free,” or “get 10 interviews for a penny and commit to buying ten more at the regular price in the coming year.” Many other deals are possible. As with selecting an interview, the consumer might click on a deal indicator, may enter a code corresponding to a particular deal, and so on.

A credit card often provides a convenient means of making purchases via the Internet or over the phone. This is because a consumer need only communicate a piece of information, the credit card number, to the merchant. However, remote purchases become more difficult for consumers without credit or debit cards. Therefore, in some embodiments of the present invention, a consumer may purchase an interview at a point of sale (POS) terminal, a gaming device, a payphone, an ATM, or a vending machine using cash, a check, or another payment. After paying at a POS terminal or other device, the consumer might receive a code that may be used, as described previously, to access one or more interviews. The code might be printed on a card that serves as a stored value card. Every time the consumer uses the code printed on the card to listen to an interview, the price of the interview is deducted from the value of an account associated with the card. The initial value of the account may equal the purchase price of the card at the POS terminal or other device, or it may be more, or less.

A stored value card for listening to interviews may be obtained in other ways. A card might be sent to a consumer taped to a magazine, or might be sent separately in the mail. A card may also be purchased by a first consumer and sent to a second consumer as a gift. In some embodiments, a stored value card may be in the form of a card with an alternate function such as for example, a frequent shopper card, a pre-paid phone card, a player-tracking card, an ATM card, or the like.

(f) In Step S105, the Controller 102 Sends the Interview to the Consumer

In some embodiments, once the user has identified an interview, the interview may be made available to him in a number of different ways. The controller 102 may email an MP3 or other sound file containing the interview. The controller 102 may provide the consumer with streaming audio. The controller 102 may also send a compact disc or audio cassette tape containing the interview to the user via postal mail. If the consumer has selected the interview over the phone, then the interview may be played over the phone. In some embodiments, an interview selected via a Web site (or using other means) may be delivered via a phone call by the controller 102 to the consumer.

In some embodiments, consumers may be required to meet certain eligibility requirements before being sent an interview. For example, if the interview contains mature content, the consumer might have to prove he is over 18 years old in order to receive a copy of the interview. In such an example, possession of a credit card might serve as ample proof of age. In other embodiments, a consumer may only be eligible to listen to an interview over the phone if he has a subscription to the publication. This requirement may be set for example, because it may be more expensive for a controller 102 to play an interview over the phone as opposed to sending it as a sound file. The privilege of listening over the phone would therefore be granted only to good or profitable customers of the publication, such as those holding subscriptions.

It is well known that MP3's and other sound files are often distributed illegally over the Internet. The sound files often contain proprietary material, such as music. It is foreseen that unscrupulous consumers would also attempt to distribute sound files containing interviews. Therefore, the present invention envisions protective measures to discourage illegal distribution. In some embodiments, a consumer is given permission to distribute an interview to a limited number of third parties. Perhaps, being allowed to share an interview with a limited number of people, a consumer would feel it was only fair not to make an interview freely available to the whole world. In other embodiments, a digital watermark is placed in the sound file. Digital watermarking is a well-known technology enabled by companies such as Digimarc (http://www.digimarc.com/). With digital watermarking, a sound file may be imperceptibly altered so as to contain embedded information about the file's origin. When a controller 102 sends a sound file containing an interview to a consumer, the controller 102 might place a digital watermark containing the consumer's name. If the consumer later tries to post a copy of the same file on the Web, the controller 102 would recognize the digital watermark in the file and may place sanctions on the consumer.

There are many possible sanctions the controller 102 might place on a consumer for illegal distribution of its interviews. The controller 102 might take legal action against the consumer. The controller 102 might place a charge on the consumer's credit card. The controller 102 might publicize the consumer as an illicit distributor. The controller 102 may restrict the consumer from making further purchases from the controller.

If, for any reason, a consumer has been restricted from making purchases from the controller, then the controller 102 may take measures to prevent the consumer from making purchases under a different identity. To begin with, the controller 102 may flag the accounts of any consumers who are restricted in their purchases. Then, anytime a consumer attempts a purchase, information about the consumer may be compared to information contained in the flagged accounts. If there is a match in name, address, credit card number, or in any other respect, the consumer may be denied the privilege of making a purchase.

In some embodiments, advertisements may be played during interviews. The ads might be for completely unrelated products or services, for other interviews, or for material related to the current interview. For example, Paula Jones may spend the first part of an interview explaining her childhood. The journalist might then ask her, “So what happened on that fateful afternoon?” Then a commercial message might ensue for a minute before Paula Jones answers. The message might advertise an upcoming issue of the publication. The message might advertise a flower bouquet from the florist whose flowers were given to Paula's coworkers. The message may be a beer commercial.

In some embodiments, a consumer need not make a phone call or access the Internet in order to select an interview. Interviews may instead be sent directly to a user device 104, such as a personal computer (PC), or a personal digital assistant (PDA). The consumer may have already paid or agreed to pay for the interviews, and so may be free to listen to them. Alternatively, the interviews may be “locked.” That is, interviews may be encrypted or otherwise unavailable to anyone without an “unlock key.” An unlock key may take the form of a decryption key or a password that enables the function of software which would play the interview. Many other types of locking and unlocking mechanisms are possible. In order to unlock an interview and listen to it, a consumer might pay the controller 102 for an unlock key. Once the user has obtained the unlock key from the controller, the user may apply the unlock key to the locked interview and access the interview.

Embodiments in which a consumer pays for an unlock key, rather than paying directly for the interview, may have some marketing advantages. A consumer may be more tantalized by the prospect of listening to an interview if the consumer knows the interview is already on his PDA. All the consumer need do is unlock the interview, as opposed to downloading the interview from a remote location. Therefore, a consumer may be more likely to purchase an unlock code than an interview itself.

In some embodiments, interviews may be sent directly to a user device 104 and the user may listen to as many as he wishes without paying immediately. The controller 102 may then track every time the user accesses an interview. For example, software contained on the user device 104 may send a signal to the controller 102, via the Internet, each time the user accesses a new interview and then connects to the Internet. After a given time period, or after listening to a given number of interviews, the user may be obligated to pay for those interviews to which he has listened. If the user does not, then the controller 102 may impose sanctions on the user.

Another method for tracking the interviews to which a user has accessed is for software on the user's computer to modify a base code each time the user listens to an interview. For example, when the user listens to an interview of Harvey Brown, the base code is encrypted with a key corresponding to Harvey Brown. When the user then listens to an interview of Linda Green, the code encrypted with the Harvey Brown key is further encrypted with the Linda Green key. After the consumer has listened to the two interviews, the consumer may submit the now twice-encrypted base code to the controller. In some embodiments, the code may be submitted automatically. By testing various decryption keys in various sequences on the code submitted by the consumer, the controller 102 may determine the interviews to which the consumer listened. For example, when the controller 102 applies the decrypting key corresponding to the Linda Green interview, and then the decrypting key corresponding to the Harvey Brown interview, the controller 102 is left with the base code. The controller 102 may then deduce that the consumer first listened to the Harvey Brown interview and then to the Linda Green interview. Many other code modification schemes are possible, and many other methods of tracking the interviews to which a consumer listened are possible.

In some embodiments, a consumer may be encouraged to purchase an interview already stored on his computer, by allowing the consumer to listen to a portion of the interview for free. The portion of the interview may be of the consumer's choosing or may be predefined. In some embodiments, the consumer may be sent two sound files. One may be locked, while the other is not. The file that is not locked contains a portion of an interview. The file that is locked contains a more complete version of the interview. The consumer may listen for free to a portion of the interview, but must then pay to receive an unlock key so as to listen to the more complete version of the interview. In other embodiments, a single recording may be partially locked and partially available for reviewing. Many other methods of providing an interview preview are possible.

In some embodiments, a consumer may receive a preview of an interview even when the interview is not already stored on his computer in locked form. For example, the consumer may call the controller 102 and enter a particular code to hear a preview. If the consumer so desires, he may then pay to listen to the complete version of the interview.

(g) In Step S106, the Controller 102 Pays the Source, the Journalist, and Other Benefiting Parties

In some embodiments, the source, the journalist and any other involved entities are paid in accordance with the sales of the interview and the portion of sales and/or profits due each party. For example, if each interview sold for $2.00, 5000 interviews were sold, and a source was due 5% of all sales, then the source would be paid 5% of $10000, or $500.

In some embodiments, an interview may be posted for sale long after the interview date. A source may not wish to wait for payment until the interview is no longer available for sale. Therefore, in some embodiments, a source may be paid on a periodic basis based on what interviews have been sold up until the point of payment. For example, a source may receive $200 based on a first week's sales of 4000 interviews, $100 based on a second week's sales of an additional 2000 interviews, and so on. Alternatively, the source may instead be paid in full based on a projection of how many interviews are anticipated to sell. The source might thereafter receive no payments, even if more interviews sell than were projected. In some embodiments, the source may be paid every time payments due to him exceed a certain amount. For example, the source may be paid whenever he is owed more than $1000 by the controller 102. Combinations of the above payment methods are also possible. A source might be paid at the end of every month for sales during that month, and may be paid when he is due more than $1000, regardless of the date. Many other payment methods are possible. Similar payment methods may also apply to the journalist and to other benefiting parties, such as the sports franchise of the source.

Payments may be made by cash, check, money order, credits to a financial account, etc. Where goods or services are used as payments, these may be shipped directly, or via third parties. Goods may also be paid out using coupons or other methods. Payments may be made to the source or to a designated beneficiary of the source. If payments are to occur in the form of recognition, then the source may be recognized, for example, by having his interview promoted in subsequent magazine articles.

(h) In Step S107, the Controller 102 Receives Further Input Regarding the Interview

Once a story has been published in a publication, other sources may come forward with new information about the story. Perhaps the information reveals new details or the information supports the story or contradicts something in the story. In any case, a new source may then contact the controller 102 and offer to participate in an interview. Many of the above described methods of this invention may then apply to this new source. However, where a story has already been published in a printed media, by the time the new source contacts the controller 102, the new source's interview may not be promoted by an advertisement proximate to the original article. Descriptors of the new interview may be added to the controller's Web site. The descriptors of the new interview may be added to the same Web page where promoted interviews are described, or the new interviews may be accessed through hyper-links from the Web page of the promoted interviews. In some embodiments, the new interview may be advertised in subsequent issues of the publication or, if the original story was published via a Web site, the original publication may be updated. An advertisement might state, for example, “We have more information on last week's story about Rosie O'Donnell. Go to http://www.insidescoop.com/RosieNew.html to hear a brand new interview with Rosie's neighbor.” In some embodiments, the new interviews will result in new articles. In such a case, the new interviews may be advertised as described above.

### F. EXAMPLE ILLUSTRATIVE EMBODIMENTS OF THE INVENTION

The following very specific examples are provided to illustrate particular embodiments of the present invention, particularly from the perspective of the users of the system and interview participants.

### 1. Example 1

A journalist named Jane interviewed Ivan, a prominent politician, on the subject of election finance reform. Before starting the interview, Jane told Ivan that if he would be uncomfortable answering any question on the record, he could simply say “off the record” and Jane would not report what he said. Jane then turned on her digital audio recorder and began the interview. She began by saying, “question” and then asked her first question: Why is campaign finance reform such a big issue this year? Jane then said, “end question.” John proceeded to answer the question, speaking for 6 minutes and 20 seconds.

Jane repeated the process of saying, “question,” asking her second question, and then saying, “end question.” However, this time, Ivan was uncomfortable answering on the record.

So Ivan began by saying, “off the record.” Jane repeated the phrase, and then Ivan gave Jane an answer for her own edification.

When Ivan had finished with his answer, Jane said, “on the record.” Now, once again, she said, “question,” asked her third question, and then said, “end question.” Ivan was comfortable answering and proceeded to do so for 3 minutes and 45 seconds. When Ivan was finished, he indicated that he had to leave for a meeting, so Jane said, “end interview.”

After interviewing Ivan, Jane took her digital audio recorder back to her office and uploaded the audio file containing the interview onto her PC. She then initiated a program to modify the interview and extract descriptors (meta-tags) for selling the interview to the public. The program, employing voice recognition technology, combed through the interview, searching for key phrases. When it encountered the word “question,” the program began transcribing the subsequent audio into text. It transcribed the following: “Why is campaign finance reform such a big issue this year?” Then the program encountered the phrase “end question,” and stopped transcribing. The program then noted the elapsed time between the phrase “end question” and the next occurrence of the phrase “question.” This time was recorded in memory as 6 minutes, 20 seconds.

The program transcribed the second question in a similar fashion, but then encountered the phrase “off the record.” The program then deleted the second question from the audio transcript, and deleted all subsequent audio until it encountered the phrase “on the record.” It then proceeded as before, transcribing the third question. When it encountered the “end interview” phrase, it was done analyzing the audio file.

The program then prompted Jane to enter the name of the interviewee and the subject of the interview. She did as asked. The program then generated a Web page containing interview information, including Ivan's name, the subject of the interview, and the two transcribed questions. Under each question was listed the time of the response and an icon that looked like an audio speaker. A price of four dollars was listed under the first question, and a price of two dollars under the second.

The program also had an output for Jane. If Jane referred to the interview in one of her future articles, she could add a footnote giving the Web address of the article: http://www.IvanInterview2.com.

Joe worked for an organization that was a major contributor to political campaigns. He read an article of Jane's where she quoted Ivan. Joe noticed the footnote at the end of the article that referred the reader to the full audio transcript of the interview with Ivan. The footnote listed the Web address, http://www.IvanInterview2.com. Joe logged on and went to the given address using his Web browser. At the Web site, Joe was able to see Ivan's name, the subject of the interview, and the two transcribed questions from the interview, along with the duration of the answers and the price of listening to the answers. Joe was interested in the first question asking why campaign finance reform was such a big issue. He clicked on the speaker icon under the first question. A screen then came up asking Joe to enter his credit card number so as to pay the price of four dollars for listening to the answer to the first question. Joe typed in his corporate account number and agreed to the charges. Then Windows Media Player® popped up on his screen, and began playing the audio answer to the first question.

### 2. Example 2

Sam was walking home after his late night shift as a security guard at a Manhatten bank. On his way home, he approached a night-club. A shouting match was in progress outside the night-club. Not wanting to be caught in the middle of it, Sam stopped walking and watched from a safe distance. He noticed one of his favorite singers amongst the two quarreling groups. A few strong words and threats were exchanged. There was even some pushing. But soon, a bouncer from the night club dispersed the quarrelers. Sam continued his walk home.

The next day, Sam contacted a tabloid publication, the Swooper. Over the phone, he briefly described to a journalist what he had witnessed. The journalist said the Swooper might be interested and would call back. That afternoon, the journalist called Sam and offered to pay him for an interview. Sam would receive $100 up front, and would receive 5% of any revenue from the sale of his interview to the public. The interview would sell for $1.00. Sam agreed, provided, that his voice would be disguised enough so no one would recognize him. Sam did not want to get on the bad side of his favorite singer, even though the singer did not know Sam. The journalist assured Sam that his voice would be disguised using an expensive voice scrambling software package.

The journalist then interviewed Sam over the phone for about ten minutes. The journalist had his phone connected to his personal computer. Using digital recording software, the journalist was able to record the entire interview as a sound file stored on his computer. The journalist sent the sound file to an editor of the Swooper. The editor removed what he perceived to be boring and redundant portions of the interview. The modified transcript of the interview now lasted only three minutes. The editor also ran the modified transcript through the voice scrambling software. The editor activated the scrambling function only during portions of the interview where Sam spoke. As a result, in the final transcript, only Sam's voice was disguised.

The journalist that interviewed Sam wrote a short article detailing the incident Sam had witnessed. At the end of the article was an advertisement for the interview with Sam. It said, “. . . meanwhile, a dismayed fan stood by watching. Hear how this incident affected him. Go to http://www.swooper.com/nightclub.html. 3 stars, male interviewee, 3 minutes, only $1.00!”

The interview with Sam was put up for sale as a download on the Swooper Web site. Two thousand copies were sold before it was removed from the site a week later. Sam collected $100 up front, and $100 as the 5% of sales, for a total of $200.

Linda read the article in the Swooper about the shouting match outside the Manhatten night-club involving the famous singer. She was interested in hearing the interview with the “dismayed fan,” so she went to went to the Web site indicated in the accompanying advertisement. She came to a page entitled “Dismayed Fan Witness to Night Club Scuffle.” To listen to the interview with the fan, she was instructed to enter a credit card number so as to pay the $1.00 charge. Linda did so, and was then allowed to download the interview sound file. She then listened to it on her PC.

G. Additional Embodiments of the Invention

The following are example alternative variations which illustrate additional embodiments of the present invention. It should be understood that the particular variations described in this section may be combined with the different embodiments, or portions thereof, described above in any manner that is practicable. These examples do not constitute a definition or itemization of all possible embodiments, and those skilled in the art will understand that the present invention is applicable to many other embodiments. Further, although the following examples are briefly described for clarity, those skilled in the art will understand how to make any changes, if necessary, to the above-described apparatus and methods to accommodate these and other embodiments and applications.

The present invention may include the additional step of verifying that the consumer is legally able to enter into an agreement to purchase the information. For example, an agreement may be legally unenforceable if the purchaser is under the age of 18. Thus, the controller 102 may, for example, consult a database of publicly available birth records. If the purchaser possesses an item, such as a credit card, that is given out on an restrictive basis, then the controller 102 may infer the purchaser's eligibility from the purchaser's possession of the item.

The present invention may include the additional step of alerting an interviewee that a consumer has purchased information related to that interviewee. In some embodiments, the interviewee or others may be interested in tracking the number of requests for a particular recording. In some embodiments, information may receive ratings based on how often it is purchased. The ratings may be used to promote additional sales of the information. In some embodiments, interviewers and interviewees may receive a percentage of revenues and or profits from the sale of recordings in which they participated.

In some embodiments users are permitted to subscribe to a service wherein the users are emailed all recordings related to a particular topic or involving a particular interviewee. For example, a user may want to purchase a subscription to every word their favorite celebrity says in an interview.

While the description of the invention has been illustrated using audio and video interviews, the invention applies to any information that is supplementary to a news story or to any other primary source of information. Full text versions of an audio interview may be redacted and made available for reading by the public. Information that was originally conveyed in text format, such as an email message, may similarly be redacted and presented to the public for reading. The text of the email may even be converted to audio using voice synthesis or other technology. The present invention may be applied to supplementary video information as well. Portions of a video may be used as meta-tags in order to interest a potential viewer in watching the rest of the video.

In some embodiments, an interviewee may be willing to convey information but does not want the information attributed to him. The interviewer may use the tags “for attribution” and “not for attribution” in order to communicate the interviewee's desire to the redacting software. There is then the problem of presenting the information to the public without allowing the interviewee's voice to give away the source of the information. Thus, in some embodiments, information that is not for attribution is transcribed into text using a voice recognition module, before being presented to the public. In other embodiments, the information is presented in audio format, but a filter is applied to the audio so as to modify the sound of the interviewee's voice, and make it unrecognizable. Also, information that is not for attribution may be presented in a format unlike a typical question-answer format. The reason is that merely disguising the voice for one of many answers in an interview still leads a listener to believe that the disguised voice belongs to the same person as answered the other questions. Therefore, information that is not for attribution may be presented as background information for the interview rather than as part of the interview itself.

In other embodiments, additional tags for use during the interview include a “background” tag which represents information that may be included as an introduction to the interview, but may not be presented as if it was spoken by the interviewee. A “made a mistake” tag may be used when an interviewee realizes that he misstated some information and would like for the information not to be made available to the public.

In some embodiments a news organization may have dedicated staff members just for reviewing either raw or redacted interview transcripts to ensure nothing is made available to the public that should not be.

In some embodiments, a reference to an interview in a document may be a hypertext link, leading directly to the Web page on which the interview is displayed.

Some embodiments may include the additional step of archiving the interview, either raw or redacted, by storing it in an interview database.

In some embodiments, the rules of engagement may be voiced by an interviewer, interviewee, or third party, and recorded with the transcript of the interview. That way, there is a clear record of the rules of engagement. Furthermore, it may be clear that both the interviewee and the interviewer knew the rules of engagement. For example, if the interview transcript has the interviewee reading the rules of engagement and saying, “I understand,” then there is a clear record that the interviewee understood the rules of engagement. The clear record of the rules of engagement may aid in any subsequent dispute. In some embodiments, the record of the rules of engagement may be used by the controller 102 to customize a redaction process to accommodate the particular rules chosen.

In some embodiments, portions of an interview transcript may be removed because certain statements lack the proper context to be understood by a listener. Those statements might therefore be misunderstood and may lead to bad feelings. Therefore, one aspect of redaction may include the addition of contextual information to an interview transcript so that statements contained in the transcript might be better understood. The added information may be voiced by any person or by a machine or computer with voice synthesis capabilities. Contextual information may also appear as text alongside other meta-tags describing the interview.

In some embodiments, many factors may be considered in calculating the price of receiving all or a portion of a recording. These factors may include the length of the interview portion, the status or stature of the interviewee or interviewer, the relevance or value of the information discussed in the interview, the subject of the interview, the date, time, or location at which the interview was conducted, the subject, placement, length, or printing date of the article referencing the interview, the age, salary, net worth, place of employment, place of residence, purchasing history, or other information about the purchaser, the number of times the interview has been purchased already, ratings given to the interview or any party to the interview by purchasers or other critics. Subjective elements factoring into the price may be determined by the interviewee, the interviewer, the editor, a subject expert, or any other person or machine. For example, the editor of a paper may judge the importance of information contained in an interview.

In some embodiments, it may be desirable to discourage deceitful redactions. For example it may be desirable to discourage an associate of the interviewer from substituting a second question for a first question on the transcript, thereby making it appear that an interviewee has answered the second question rather than the first. Therefore, in some embodiments, an interviewee may record the interview session on his own, and keep for his own records the unaltered interview transcript. The interviewee may also be given a copy of the raw interview transcript. In other embodiments, the recording device may use various portions of the interview as input to a hash function. For example, the bit-representation of the first question and answer of the interview transcript may be used as input to a hash function, generating a single 32-bit sequence as output. The interviewee may be given the 32-bit sequence to keep for his records. If the first question and answer are later altered, then running the altered versions through the same hash function will most likely result in a different output, allowing the interviewee to demonstrate that an alteration took place. In still other embodiments, the digitized transcript of the interview may be digitally time-stamped, or digitally watermarked. Many other ways of discouraging alterations are possible.

Audio interviews are one type of content that is supplemental to a story. However, there may be many other types of supplemental content. These too may be advertised in a publication proximate to the story. Examples of supplemental content include pictures, video, text, and dramatizations related to the story. Pictures may depict people or places that are relevant to the story. A picture might depict a bar where a celebrity fired a gun, a piece of evidence retrieved from a crime scene, or a person in the company of a celebrity. A video might show a celebrity as he is led away in handcuffs, or as he loses his temper. A dramatization may be a video or audio reenactment of a shouting match between a celebrity and spouse. Many other depictions are possible, and other mediums for depicting are possible.

Supplementary content may be accessed through a Web site, email, a phone number, a fax number, etc. In addition to being promoted in a publication, supplementary content might be promoted before, during, or after an interview. For example, one of the commercials in an interview might provide a phone number for the consumer to call in order to listen to the reenactment of the scene described by the source in his interview.

In some embodiments a consumer may be presented with the option of purchasing a souvenir related to a story. For example, a consumer might purchase a baseball that was thrown in a winning pitch of a game, or a dress similar to one the subject of a story was wearing. Souvenirs may be advertised in a similar manner to interviews and other supplementary content.

In some embodiments, the controller 102 or another party may subsidize any purchase the consumer makes if the consumer also purchases or agrees to purchase one or more interviews. For example, a consumer may be in the process of paying for orange juice at a POS terminal. The cashier may offer the consumer a $1 discount on the orange juice if the consumer will buy a stored value card giving him $3 to use for listening to interviews. The subsidy might particularly provide a discount on a first purchase of interviews in exchange for the purchase or agreement to purchase a second group of interviews.

In some embodiments an interview may have corporate or other sponsors who gain exposure from their sponsorship. The corporate sponsors may, for example, pay the source or pay the controller. The corporate sponsors may also wish to use the source or the source's voice in their own advertisements.

In addition to the rating system for interviews and for sources described above, in some embodiments a system of consumer feedback by which the ratings are generated may be included. In some embodiments, a consumer may listen to an interview and then go to a Web site or call a phone number provided for feedback. The consumer may then enter identifying information about the interview. In some embodiments, the controller 102 may recognize the interview based on what has been sold to the consumer, and so may not require identifying information about the interview. At a Web site, a form may ask the consumer for feedback along various scales. For example, “How would you rate the entertainment value of this interview on a scale of 1 (least entertaining) to 5 (most entertaining)?” A similar process may occur over the phone. The consumer may have the option of providing as much or as little rating information as he so desires. The consumer may receive compensation for rating an interview in the form of money, products, recognition, or free access to other interviews.

In some embodiments, when a witness provides details of an event or a sports figure provides commentary on a game, the commentary may be provide along with addition information such as, for example, a video of the scene of the event or a video replay of the relevant portion of the game. In some embodiments, a consumer might view a particular play, for example, and hear the commentary of why the play unfolded as it did.

In some embodiments, the identity of a source may be revealed to a consumer only after the consumer has purchased the interview. The identity may be revealed at the beginning of the transcript of the interview, or at the end so as to maintain suspense. In some embodiments, the consumer might pay extra in order to hear the identity of the source.

### H. CONCLUSION

It is clear from the foregoing discussion that the disclosed systems and methods to market supplemental information represents an improvement in the art of electronic commerce and automated processing, gathering, and sales of information. While the method and apparatus of the present invention has been described in terms of its presently preferred and alternate embodiments, those skilled in the art will recognize that the present invention may be practiced with modification and alteration within the spirit and scope of the appended claims. The specifications and drawings are, accordingly, to be regarded in an illustrative rather than a restrictive sense.

Further, even though only certain embodiments have been described in detail, those having ordinary skill in the art will certainly appreciate and understand that many modifications, changes, and enhancements are possible without departing from the teachings thereof. All such modifications are intended to be encompassed within the following claims.

What is claimed is:

1. A method of compensating an interview participant comprising:
offering a transcript of an interview for sale; and
compensating a participant in the interview an amount related to sales of the interview transcript.

2. The method of claim 1 wherein the amount is based on a percentage of revenue from the sales of the interview transcript.

3. The method of claim 1 wherein the amount is based on a percentage of profit from the sales of the interview transcript.

4. The method of claim 1 wherein the amount is based on a number of copies of the interview transcript sold.

5. The method of claim 1 wherein the amount is based on at least one of a rating of an interviewer and a number of subsequent interviews that result from the interview.

6. The method of claim 1 wherein the amount is based on a first percentage of revenue from the sales of the interview transcript during a first time period and a second percentage of revenue from the sales of the interview transcript during a second time period.

7. The method of claim 1 wherein the amount is based on a first percentage of profit from the sales of the interview transcript during a first time period and a second percentage of profit from the sales of the interview transcript during a second time period.

8. A method of compensating an interview participant comprising:
offering a recording of an interview for sale; and
compensating a participant in the interview an amount related to sales of the interview recording.

9. The method of claim 8 wherein the amount is based on a percentage of revenue from the sales of the interview recording.

10. The method of claim 8 wherein the amount is based on a percentage of profit from the sales of the interview recording.

11. The method of claim 8 wherein the amount is based on a number of copies of the interview recording sold.

12. The method of claim 8 wherein the amount is based on at least one of a rating of an interviewer and a number of subsequent interviews that result from the interview.

13. The method of claim 8 wherein the amount is based on a first percentage of revenue from the sales of the interview recording during a first time period and a second percentage of revenue from the sales of the interview recording during a second time period.

14. The method of claim 8 wherein the amount is based on a first percentage of profit from the sales of the interview recording during a first time period and a second percentage of profit from the sales of the interview recording during a second time period.

15. A method of compensating an interview participant comprising:
offering a transcript of an interview for sale; and
compensating a participant in the interview based upon sales of the interview transcript.

16. The method of claim 15 wherein the compensation is in the form of merchandise.

17. The method of claim 15 wherein
the compensation is a first set of merchandise provided if less than a threshold number of the interview transcripts are sold, and
the compensation is a second set of merchandise if greater than the threshold number of interviews are sold.

18. The method of claim 15 wherein the compensation is conditional on participation of other parties in other interviews.

19. The method of claim 15 wherein the compensation includes compensation based on sales of related interview transcripts.

20. The method of claim 15 wherein the compensation is in the form of recognition for the interview participant as a source.

21. The method of claim 15 wherein the compensation is in the form of donation to charity made on behalf of the interview participant as a source.

22. The method of claim 15 wherein the compensation is dependant on at least one demographic of buyers to whom the interview is sold.

23. A method of selectively distributing modified interview transcripts comprising:
modifying a first interview transcript to create a second interview transcript;
modifying the first interview transcript to create a third interview transcript;
providing the second interview transcript to a first subset of buyers meeting a first set of criteria; and
providing the third interview transcript to a second subset of buyers meeting a second set of criteria.

24. The method of claim 23, wherein the second interview transcript is different from the third interview transcript.

25. The method of claim 23, wherein the second interview transcript shields an identity of an interview participant to a different degree than does the third interview transcript.

26. The method of claim 23, wherein the first set of criteria describes a geographic region in which a buyer resides.

27. The method of claim 23, wherein the first set of criteria describes a set of identities, wherein at least one of the set of identities corresponds to a buyer in the first subset of buyers.

28. The method of claim 23, wherein the first set of criteria describes a set of identities, wherein at least one of the set of identities does not correspond to a buyer in the first subset of buyers.

29. The method of claim 23, wherein the first set of criteria describes a consumer status of a buyer in the first subset of buyers.

30. A method of compensating a publisher comprising:
offering a publisher of a publication an agreement providing a guarantee of a monetary amount in exchange for publishing an advertisement for content supplementary to an article in the publication; and
providing to the publisher a difference between the fixed monetary amount and a revenue amount derived from sales of the content supplementary to the article.

31. The method of claim 30, wherein the monetary amount is related to an anticipated amount of revenue that would have been derived from space used for advertising the content supplementary to the article, if the space was used for another purpose.

32. The method of claim 30, wherein the monetary amount is related to a value of a space in the publication used for advertising the content supplementary to the article.

33. A method of compensating a publisher comprising:
offering a publisher of a publication an agreement providing a guarantee of a monetary amount in exchange for publishing an advertisement for content supplementary to an article in the publication; and
providing to the publisher a percentage of revenue derived from sales of the content supplementary to the article that exceeds the monetary amount.

34. A method of marketing supplementary content comprising:
publishing a document; and
publishing a promotion for supplementary content proximate to the document,
wherein the supplementary content includes a redacted interview transcript.

35. The method of claim 34, wherein the document includes a magazine article.

36. The method of claim 34, wherein the redacted interview transcript relates to the document.

37. The method of claim 34, wherein the supplementary content includes a reenactment of an event referred to in the document.

38. The method of claim 37, wherein the reenactment of an event referred to in the document is in the form of an audio recording.

39. The method of claim 37, wherein the reenactment of an event referred to in the document is in the form of a video recording.

40. The method of claim 34, wherein the promotion directs a reader to an Internet site.

41. The method of claim 34, wherein the promotion directs a reader to a voice response unit.

42. The method of claim 34, wherein the promotion includes a display of a price for the supplementary content.

43. The method of claim 34, wherein the promotion includes a display of at least one rating of the supplementary content.

44. The method of claim 43, wherein the at least one rating of the supplementary content includes a rating of entertainment value.

45. The method of claim 43, wherein the at least one rating of the supplementary content includes a rating of interview quality.

46. The method of claim 43, wherein the at least one rating of the supplementary content includes a rating of interview value.

47. The method of claim 43, wherein the at least one rating of the supplementary content includes a rating of interview newsworthiness.

48. The method of claim 43, wherein the at least one rating of the supplementary content includes a rating of relevance to the document.

49. The method of claim 34, wherein the promotion is in the form of a continuation of the document.

50. The method of claim 34, wherein the promotion and the document are on a same page.

51. The method of claim 34, wherein the promotion uses a predefined nomenclature.

52. The method of claim 51, wherein the nomenclature includes individual letters representing words descriptive of the supplementary content.

53. The method of claim 51, wherein the nomenclature includes at least one of “M” indicating “male,” “V” indicating “violent,” “F” indicating “female,” “R” indicating “reenactment,” “A” indicating “abridged recording,” and “O” indicating “original recording.”

54. A method of selling supplementary content comprising:
conducting an interview;
publishing a document related to the interview;
marketing the interview for sale in a promotion printed in proximity to the document;
processing a transcript of the interview to create a processed transcript; and
making the processed transcript available for sale.

55. The method of claim 54, wherein processed transcript is made available for sale as a sound file.

56. The method of claim 55, wherein the sound file is downloadable from an Internet site.

57. The method of claim 55, wherein the sound file may be purchased using a credit card number.

58. The method of claim 55, wherein the sound file may be purchased using a code.

59. The method of claim 55, wherein the sound file may be purchased as part of a subscription.

60. The method of claim 54, wherein making the processed transcript available for sale includes
selling access to the processed transcript; and
providing a password to a user which may be used to gain access to the processed transcript.

61. The method of claim 54, wherein making the processed transcript available for sale includes
transmitting the processed transcript to a user device.

62. The method of claim 54, wherein making the processed transcript available for safe includes
transmitting the processed transcript to a user device before a user has paid for the processed transcript;
receiving an indication that the user has reviewed the processed transcript; and
charging the user for the processed transcript.

63. The method of claim 54, wherein making the processed transcript available for sale includes
transmitting the processed transcript to a user device in locked form; and
charging the user for an unlock code.

64. The method of claim 54, wherein making the processed transcript available for sale includes
transmitting the processed transcript to a user device in locked form;
transmitting a portion of the processed transcript to a user device in unlocked form to serve as a preview; and
charging the user for an unlock code.

65. A method of creating supplementary content comprising:
recording an interview between a journalist and a source; and
processing the recording of the interview to create an interview transcript.

66. The method of claim 65, wherein processing the recording includes disguising a characteristic of a voice of the source.

67. The method of claim 66, wherein the characteristic of the voice of the source includes at least one of accent, dialect, pitch, and gender.

68. The method of claim 65 further including discouraging illegal copying and distribution of the interview.

69. The method of claim 68 wherein discouraging illegal copying and distribution includes permitting a limited number of free copies of the interview transcript to be made.

70. The method of claim 68 wherein discouraging illegal copying and distribution includes inserting a digital watermark in the interview transcript.
